(19) United States
(12) Patent Application Publication
(10) Pub. No.: US 2026/0031547 A1
(43) Pub. Date: Jan. 29, 2026

(54) BASE STATION ANTENNAS HAVING AN ACTIVE ANTENNA MODULE(S) AND RELATED MOUNTING SYSTEMS AND METHODS

(71) Applicant: Outdoor Wireless Networks LLC, Claremont, NC (US)

(72) Inventors: Sammit PATEL, Dallas, TX (US); Xiang LI, Suzhou (CN); YongJie XU, Suzhou (CN); Ligang WU, Suzhou (CN); XiaoHua HOU, Richardson, TX (US); Qiyun GU, Suzhou (CN); Guolong XU, Suzhou (CN)

(21) Appl. No.: 19/099,824

(22) PCT Filed: Jun. 20, 2023
(86) PCT No.: PCT/US2023/025740

§ 371 Date: Jan. 30, 2025

Related U.S. Application Data
(60) Provisional application No. 63/371,990, filed on Aug. 19, 2022.
(60) Provisional application No. 63/380,402, filed on Oct. 21, 2022.

(51) Int. Cl. H01Q 21/24; H01Q 1/12; H01Q 1/24; H01Q 3/06; H01Q 5/48; H01Q 15/00

(52) U.S. Cl. CPC H01Q 21/24; H01Q 1/1228; H01Q 1/246; H01Q 3/06; H01Q 15/0013; H01Q 5/48

(57) ABSTRACT

Base station antennas include an externally accessible active antenna module releasably coupled to a target mounting structure behind a rear of a base station antenna housing using active antenna module mounting brackets that attach to the active antenna module, project rearward of the active antenna module and are configured to directly attach to a target mounting structure such as a pole. The base station antenna housing has a passive antenna assembly that cooperates with the active antenna module.

### RELATED APPLICATION(S)

The present application claims priority from and the benefit of U.S. Provisional Patent Application Ser. No. 63/371,990, filed Aug. 19, 2022, and U.S. Provisional Patent Application Ser. No. 63/380,402, filed Oct. 21, 2022, the disclosure of which are hereby incorporated herein in their entireties.

### FIELD

The present invention generally relates to radio communications and, more particularly, to base station antennas for cellular communications systems.

### BACKGROUND

Cellular communications systems are well known in the art. In a cellular communications system, a geographic area is divided into a series of regions that are referred to as “cells” which are served by respective base stations. The base station may include one or more antennas that are configured to provide two-way radio frequency (“RF”) communications with mobile subscribers that are within the cell served by the base station. In many cases, each cell is divided into “sectors.” In one common configuration, a hexagonally shaped cell is divided into three 120° sectors in the azimuth plane, and each sector is served by one or more base station antennas that have an azimuth Half Power Beamwidth (HPBW) of approximately 65°. Typically, the base station antennas are mounted on a tower or other raised structure, with the radiation patterns (also referred to herein as “antenna beams”) that are generated by the base station antennas directed outwardly. Base station antennas are often implemented as linear or planar phased arrays of radiating elements.

In order to accommodate the increasing volume of cellular communications, cellular operators have added cellular service in a variety of new frequency bands. In order to increase capacity without further increasing the number of base station antennas, multi-band base station antennas have been introduced which include multiple linear arrays of radiating elements. Additionally, base station antennas are now being deployed that include “beamforming” arrays of radiating elements that include multiple columns of radiating elements. The radios for these beamforming arrays may be integrated into the antenna so that the antenna may perform active beamforming (i.e., the shapes of the antenna beams generated by the antenna may be adaptively changed to improve the performance of the antenna). These beamforming arrays typically operate in higher frequency bands, such as various portions of the 3.3-5.8 GHz frequency band. Antennas having integrated radios that can adjust the amplitude and/or phase of the sub-components of an RF signal that are transmitted through individual radiating elements or small groups thereof are referred to as “active antennas.” Active antennas can generate narrowed beamwidth, high gain, antenna beams and can steer the generated antenna beams in different directions by changing the amplitudes and/or phases of the sub-components of RF signals that are transmitted through the antenna.

FIGS. 1 and 2 illustrate an example of a prior art “active” base station antenna 10 that includes a pair of beamforming arrays and associated beamforming radios. The base station antenna 10 is typically mounted with the longitudinal axis L of the antenna 10 extending along a vertical axis (e.g., the longitudinal axis L may be generally perpendicular to a plane defined by the horizon) when the antenna 10 is mounted for normal operation. The front surface of the antenna 10 is mounted opposite the tower or other mounting structure, pointing toward the coverage area for the antenna 10. The antenna 10 includes a radome 11 and a top end cap 20. The antenna 10 also includes a bottom end cap 30 which includes a plurality of connectors 40 mounted therein. As shown, the radome 11, top cap 20 and bottom cap 30 define an external housing 10h for the antenna 10. An antenna assembly is contained within the housing 10h.

FIG. 2 illustrates that the antenna 10 can include one or more radios 50 that are mounted to the housing 10h. As the radios 50 may generate significant amounts of heat, it may be appropriate to vent heat from the active antenna in order to prevent the radios 50 from overheating. Accordingly, each radio 50 can include a (die cast) heat sink 54 that is mounted on the rear surface of the radio 50. The heat sinks 54 are thermally conductive and include a plurality of fins 54f. Heat generated in the radios 50 passes to the heat sink 54 and spreads to the fins 54f. As shown in FIG. 2, the fins 54f are external to the antenna housing 10h. This allows the heat to pass from the fins 54f to the external environment. Further details of example conventional antennas can be found in co-pending PCT Publication Nos. WO2019/236203 and WO2020/072880, the contents of which are hereby incorporated by reference as if recited in full herein.

### SUMMARY

Embodiments of the present invention are directed to a base station antenna assembly that includes: a housing having a passive antenna assembly and a plurality of mounting brackets coupled directly or indirectly to a rear of the housing and to a mounting structure; and at least one active antenna bracket coupled to the active antenna module and attached directly to the mounting structure whereby the active antenna module is separately attachable to the mounting structure and resides behind the housing of the passive antenna assembly.

The active antenna module can include a massive multiple input multiple output (mMIMO) antenna array of radiating elements positioned in front of an active reflector.

The passive reflector in the housing can be electrically coupled to the active reflector to thereby provide a common electrical ground.

The passive reflector in the housing can be provided as at least one frequency selective surface (FSS).

The passive reflector in the housing can be provided as first and second FSS' stacked in a front to back direction to be in front of the active antenna module.

Other aspects are directed to a base station antenna assembly that includes: a housing of a base station antenna with a passive antenna assembly and a passive reflector in the housing; a plurality of passive antenna mounting brackets coupled to the housing and configured to attach to a mounting structure; and an active antenna module having at least one active antenna mounting bracket configured to directly attach to the mounting structure. In an installed position, the active antenna module is behind the housing of the base station antenna.

The active antenna module can be independently attachable to the mounting structure whereby the active antenna module is directly supported by the mounting structure.

The at least one active antenna mounting bracket can have at least one mounting arm that extends rearwardly of a rear of the active antenna module to the mounting structure.

The plurality of passive antenna mounting brackets can include a first passive antenna mounting bracket and a longitudinally spaced apart second passive antenna mounting bracket. The at least one active antenna mounting bracket and the active antenna module can reside between the first and second passive antenna mounting brackets.

The active antenna module can have a massive multiple input multiple output (mMIMO) antenna array of radiating elements.

The mMIMO antenna array can be positioned behind a passive reflector in the housing.

The plurality of passive antenna mounting brackets are configured to be adjustable to provide an adjustable distance between the active antenna module and a rear of the housing.

The plurality of passive antenna mounting brackets can be configured to provide an adjustable downtilt of the housing.

The plurality of active antenna mounting brackets can be configured to provide an adjustable downtilt of the active antenna module.

The plurality of passive antenna mounting brackets can be configured to provide an adjustable downtilt of the housing and the plurality of active antenna mounting brackets can be configured to provide an adjustable downtilt of the active antenna module whereby each set of brackets can be separately/individually adjustable for downtilt.

The plurality of passive antenna mounting brackets and/or the at least one active antenna bracket can be configured to be adjustable to adjust a distance between a front of the active antenna module and a rear of the housing.

The plurality of passive antenna mounting brackets can have mounting arms with a first length in a front to back direction and the at least one active antenna mounting bracket can have mounting arms with a second length in a front to back direction. The mounting arms of the at least one active antenna mounting bracket extends rearward of the active antenna module to the mounting structure and the first length can be greater than the second length.

The active antenna mounting brackets can have pole clamps on respective end portions thereof.

Other aspect of the present invention are directed to methods of installing an active antenna module to a base station antenna having a passive antenna housing with a passive antenna. The methods include attaching a plurality of passive antenna mounting brackets attached to the passive antenna housing to a target mounting structure; and before or after attaching the plurality of passive antenna brackets to the target mounting structure, attaching the active antenna module directly to the target mounting structure using at least one active antenna mounting bracket that extends rearwardly outward past a rear of the active antenna module.

The methods can further include adjusting a distance between the passive antenna housing and the active antenna module after the attaching steps to position the passive antenna housing closer to the active antenna module.

The method can further include moving at least one of the plurality of passive antenna mounting brackets to adjust a downtilt of the passive antenna housing and independently moving at least one of the at least one active antenna mounting bracket to adjust a downtilt of the active antenna module.

The passive antenna housing is attached to the target mounting structure before the active antenna module is attached to the target mounting structure.

The attaching steps are carried out so that a front of the active antenna module and a rear of the passive antenna housing are separated by a first distance and the active antenna module is supported entirely by the target mounting structure.

The method can further include moving one or both of the active antenna module and/or the passive antenna housing to be closer together while both remain attached to the target mounting structure.

The active antenna module can provide 5G operation and the passive antenna of the base station antenna can provide 4G operation.

Still other embodiments are directed to methods of installing an active antenna module to a base station antenna comprising an active antenna module and a passive antenna housing. The methods include: providing a mounting system that includes a plurality of active antenna mounting brackets; attaching the active antenna mounting brackets of the active antenna module directly to a mounting structure to thereby mount the active antenna module to the mounting structure; and mounting passive antenna brackets attached to the passive antenna housing to the mounting structure before or after attaching the active antenna mounting brackets to the target mounting structure, with the passive antenna housing positioned in front of the active antenna; then sliding the passive antenna housing rearward, while attached to the passive antenna brackets to reside closer to the active antenna module to thereby install the active antenna module to the base station antenna.

The active antenna module can provide 5G operation and the passive antenna of the base station antenna can provide 4G operation.

Other aspects of the present invention are directed to a base station antenna assembly. The base station antenna assembly includes a housing of a base station antenna comprising an antenna assembly and a plurality of antenna mounting brackets coupled to the housing and configured to attach to a mounting structure. The plurality of antenna mounting brackets include an upper antenna mounting bracket, a middle antenna mounting bracket, and a lower antenna mounting bracket. The middle antenna mounting bracket includes a rack and pinion assembly configured to adjust the housing of the base station antenna a distance from the mounting structure.

The middle antenna bracket further can include a main body having two opposing sidewalls, each sidewall having an elongated slot. The rack and pinion assembly can be coupled to an outer surface of one of the sidewalls.

The pinion of the rack and pinion assembly can be held against an outer surface of one of the sidewalls by a fastener extending through the elongated slot. The fastener can be configured to allow the pinion to rotate relative to the sidewall such that the pinion can travel back-and-forth along the rack.

An end of the fastener can be configured to engage a wrench used to rotate the pinion.

The middle antenna mounting bracket can further include a brake slider configured to engage the pinion of the rack and pinion assembly to lock the pinion in a position along the rack.

The brake slider can be secured to the middle antenna mounting bracket via a second fastener extending through the same elongated slot in the sidewall of the bracket as the fastener holding the pinion.

At least a portion of the brake slider can be configured to be received by and slide within the elongated slot of the bracket.

The brake slider can include an elliptical-shaped aperture through which the second fastener extends and allows the brake slider to slide back-and-forth relative to the fastener to engage or disengage the pinion.

Other aspects of the present invention are directed to a method of installing an active antenna module to a base station antenna comprising a passive antenna housing with a passive antenna. The method includes providing a mounting system including a plurality of antenna mounting brackets coupled to the housing and configured to attach to a mounting structure. The plurality of antenna mounting brackets includes an upper antenna mounting bracket, a middle antenna mounting bracket, and a lower antenna mounting bracket. The middle antenna mounting bracket includes a rack and pinion assembly configured to adjust the housing of the base station antenna a desired distance from the mounting structure and a brake slider configured to engage the pinion of the rack and pinion assembly. The method further includes sliding the brake slider to disengage from the pinion of the rack and pinion assembly; rotating the pinion to travel a desired direction along the rack of the rack and pinion assembly which simultaneously moves the middle antenna mounting bracket, and passive antenna housing coupled thereto, forwardly or rearwardly relative to the mounting structure; and sliding the brake slider to engage the pinion, thereby locking the housing at the desired distance from the mounting structure.

The method can further include pivoting the housing about the middle antenna mounting bracket to adjust the base station antenna to a desired angle of downtilt or uptilt.

The method can further include rotating the pinion in a first direction such that the antenna housing is moved a maximum distance from the mounting structure; mounting an active antenna module to the mounting structure behind the already mounted passive antenna housing; and rotating the pinion in a second opposite direction such that the antenna housing is moved to a minimum distance from the mounting structure, proximate to the active antenna module.

The method can further include placing a gauge between the active antenna module and the passive antenna housing to prevent the passive antenna housing from contacting the active antenna module.

Other aspects of the present invention are directed to a mounting gauge kit. The kit includes two gauge plates and two fastening mechanisms. Each gauge plate includes a rectangular main body having one or more apertures and one or more recesses along a bottom edge. Each fastening mechanism is configured to be received through the one or more apertures to secure a respective gauge plate to a clamping member of a pipe clamp for an antenna bracket secured to a passive antenna housing. The gauge plates are configured to define a location along a mounting structure to secure an upper pipe clamp for an active antenna module in relation to the clamping member of the pipe clamp for the antenna bracket.

The one or more recesses of the gauge plates can be configured to engage a fastener of the upper pipe clamp for the active antenna module.

The clamping member of the pipe clamp for the antenna bracket can include a pair of flanges extending downwardly therefrom. Each flange can include an open-ended slot extending into an aperture. The open-ended slot and aperture can be configured to receive and secure a respective fastening mechanism.

The one or more apertures can include a vertically-extending elongated aperture and a series of spaced-apart horizontally-extending elongated apertures. Each horizontally-extending apertures extends outwardly from the vertically-extending elongated aperture such that the horizontally-extending apertures are generally perpendicular to the vertically-extending aperture and generally parallel to each other. Each horizontally-extending aperture can be in fluid communication with the vertically-extending aperture.

The horizontally-extending apertures can correspond to a defined location for the upper pipe clamp for the active antenna module along the mounting structure in relation to the antenna bracket.

Each fastening mechanism can have a main body, a transition section extending outwardly from the main body. An end of the transition section can be threaded.

The main body of each fastening mechanism can have a cylindrical profile with a locking section extending radially outwardly therefrom. The cylindrical main body can be configured to be received through the aperture of a respective flange of the clamping member and the locking section can be configured to be received by the corresponding open-ended slot.

The main body of each fastening mechanism can have a draft or taper of about 1 degree.

The transition section of each fastening mechanism can be configured to be received by a horizontally-extending aperture in the gauge plate and configured to traverse and slide therein.

The threaded end of the transition section can be configured to receive a corresponding nut to lock the respective fastening mechanism in place and secure the gauge plate to the clamping member.

The threaded end of the transition section of each fastening mechanism can be sized and configured to traverse and slide within the vertically-extending aperture of the gauge plate.

The mounting gauge kit can be in combination with a base station assembly having a housing of a base station antenna including an antenna assembly. A plurality of antenna mounting brackets can be coupled to the housing and configured to attach to a mounting structure, the plurality of antenna mounting brackets including an upper antenna mounting bracket, a middle antenna mounting bracket, and a lower antenna mounting bracket.

### BRIEF DESCRIPTION OF THE DRAWINGS

FIG. 1 is a perspective view of a prior art base station antenna.

FIG. 2 is a back view of the prior art base station antenna of FIG. 1.

FIG. 3 is a side view of a mounting system for mounting an active antenna module and a passive antenna housing of a base station antenna to a mounting structure according to embodiments of the present invention.

FIG. 4 is a lateral section, simplified schematic illustration of an example base station antenna with an active antenna module coupled to a passive antenna housing according to embodiments of the present invention.

FIG. 5 is a lateral section, simplified schematic illustration of another example base station antenna with an active antenna module coupled to a passive antenna housing according to embodiments of the present invention.

FIG. 6 is a front, side perspective view of a portion of a base station antenna, without the radome(s) illustrating example radiating element arrangements according to embodiments of the present invention.

FIG. 7 is a rear, side perspective view of the mounting system of FIG. 3 without the active antenna module according to embodiments of the present invention.

FIG. 8A is an enlarged top perspective view of an upper antenna mounting bracket of the mounting system of FIG. 7 according to embodiments of the present invention.

FIG. 8B is an enlarged top perspective view of a lower antenna mounting bracket of the mounting system of FIG. 7 according to embodiments of the present invention.

FIG. 9A is an enlarged side view of a middle antenna mounting bracket of the mounting system of FIG. 7 according to embodiments of the present invention.

FIG. 9B is an enlarged top perspective view of the middle antenna mounting bracket of FIG. 9A.

FIG. 10A is a side perspective view of a brake slider according to embodiments of the present invention.

FIG. 10B is an opposing side perspective view of the brake slider of FIG. 11A.

FIG. 11A is a side view of the mounting system of FIG. 7 positioning the passive antenna at maximum down-tilt (e.g., about −5 degrees).

FIG. 11B is a side view of the mounting system of FIG. 7 positioning the passive antenna with no tilt (i.e., zero degrees)

FIG. 11C is a side view of the mounting system of FIG. 7 positioning the passive antenna at maximum up-tilt (e.g., about +5 degrees).

FIG. 12A is a side view of the mounting system of FIG. 7 illustrating the middle antenna mounting bracket adjusted such that the passive antenna is positioned the farthest possible distance from the mounting pole.

FIG. 12B is a side view of the mounting system of FIG. 12A with an active antenna module mounted to the mounting pole.

FIG. 12C is a side view of the mounting system of FIG. 12B illustrating the middle antenna mounting bracket adjusted such that the passive antenna is positioned the closest possible distance from the mounting pole.

FIGS. 13A-13C illustrate the adjustment capabilities of the mounting system according to embodiments of the present invention. FIG. 13A illustrates distance adjustment of the mounting system with only a passive antenna. FIG. 13B illustrates distance adjustment of the mounting system with a passive antenna and an active antenna module. FIG. 13C illustrates tilt adjustment of the mounting system with a passive antenna and an active antenna module.

FIG. 14 is an enlarged rear perspective view of the mounting system of FIG. 3 utilizing a mounting gauge kit according to embodiments of the present invention.

FIG. 15A is a bottom perspective view of the mounting gauge kit shown in FIG. 14.

FIG. 15B is a bottom perspective view of a modified clamping member for the mounting gauge kit of FIG. 15A.

FIG. 15C is a rear view of a gauge plate for the mounting gauge kit of FIG. 15A.

FIG. 15D is a side view of a cap bolt for the mounting gauge kit of FIG. 15A.

FIG. 15E is a perspective view of the cap bolt of FIG. 15D.

FIG. 16A is an exploded view of the mounting gauge kit of FIG. 14.

FIG. 16B illustrates movement of a cap bolt within a gauge plate of the mounting gauge kit of FIG. 14 to define the location of an active antenna module mounting kit.

FIG. 17A is an enlarged perspective side view of a gauge plate with a respective cap bolt secured thereto.

FIG. 17B is an enlarged perspective view of the opposing side view of gauge plate and cap bolt of FIG. 17A.

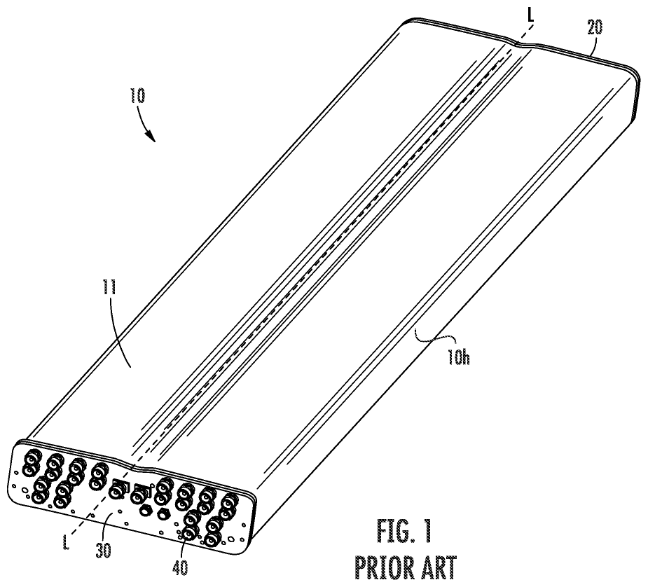

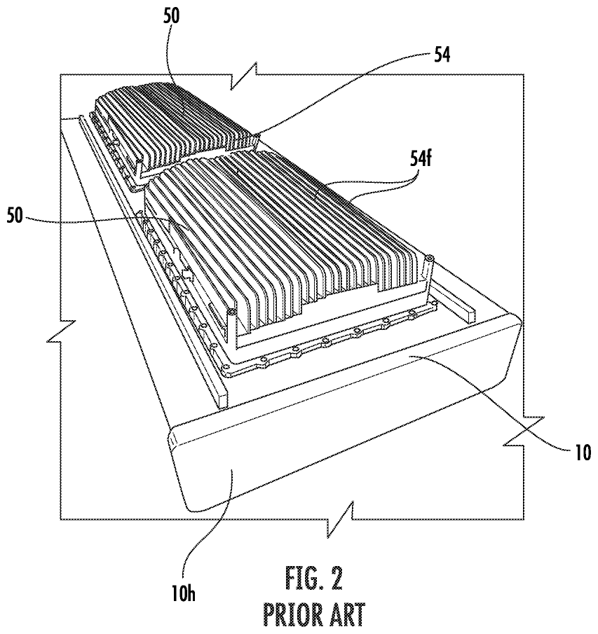

### DETAILED DESCRIPTION

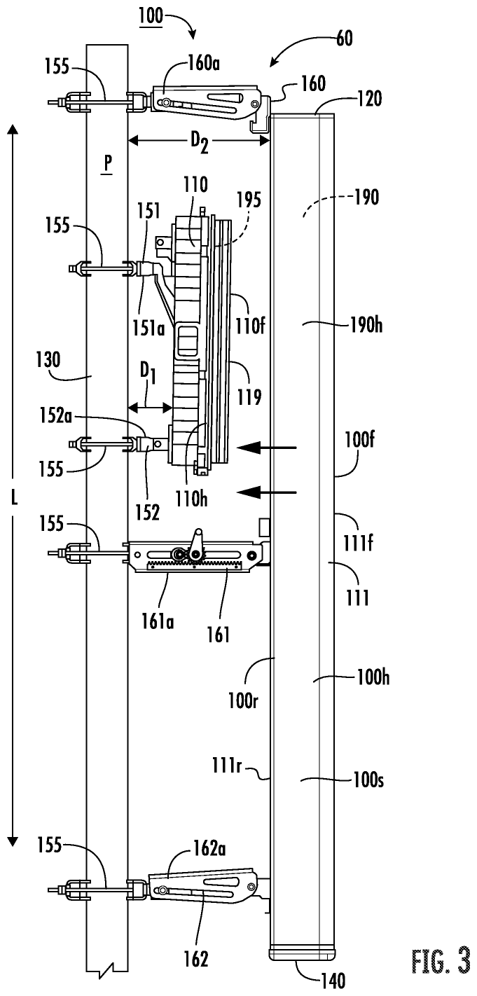

In the description that follows, a base station antenna 100 will be described using terms that assume that the base station antenna 100 is mounted for use on a tower, pole or other mounting structure with the longitudinal axis L of the antenna 100 (FIG. 3) extending along a vertical axis and the front of the base station antenna 100 mounted opposite the tower, pole or other mounting structure pointing toward the target coverage area for the base station antenna 100 and the rear of the base station antenna 100 facing the tower or other mounting structure. It will be appreciated that the base station antenna 100 may not always be mounted so that the longitudinal axis L thereof extends along a vertical axis. For example, the base station antenna 100 may be tilted slightly (e.g., less than) 10° with respect to the vertical axis so that the resultant antenna beams formed by the base station antenna 100 each have a small mechanical downtilt or uptilt.

Referring to FIG. 3, an example mounting system 60 for mounting an active antenna module 110 of a base station antenna 100 behind a passive antenna housing 190h comprising a passive antenna assembly 190. The passive antenna housing 190h can define the primary housing 100h of the base station antenna 100. The term “active antenna module” is used interchangeably with “active antenna unit,” “AAU,” “remote radio unit” or “radio” and refers to a cellular communications unit comprising radio circuitry and associated antenna elements that are capable of electronically adjusting the amplitude and/or phase of the subcomponents of an RF signal that are output to different radiating elements of an array or groups thereof. The active antenna module 110 comprises the radio circuitry and the radiating elements (e.g., a multi-input-multi-output (mMIMO) beamforming antenna array) and may include other components such as filters, a calibration network, antenna interface signal group (AISG) controller and the like. The active antenna module 110 can be provided as a single integrated unit or provided as a plurality of stackable units, including, for example, first and second sub-units such as a radio sub-unit (box) with the radio circuitry and an antenna sub-unit (box) with a multi-column array of radiating elements and the first and second sub-units stackably attach together in a front-to-back direction of the base station antenna 100, with the antenna unit closer to a front 100f (external radome) of the base station antenna 100 than the radio unit.

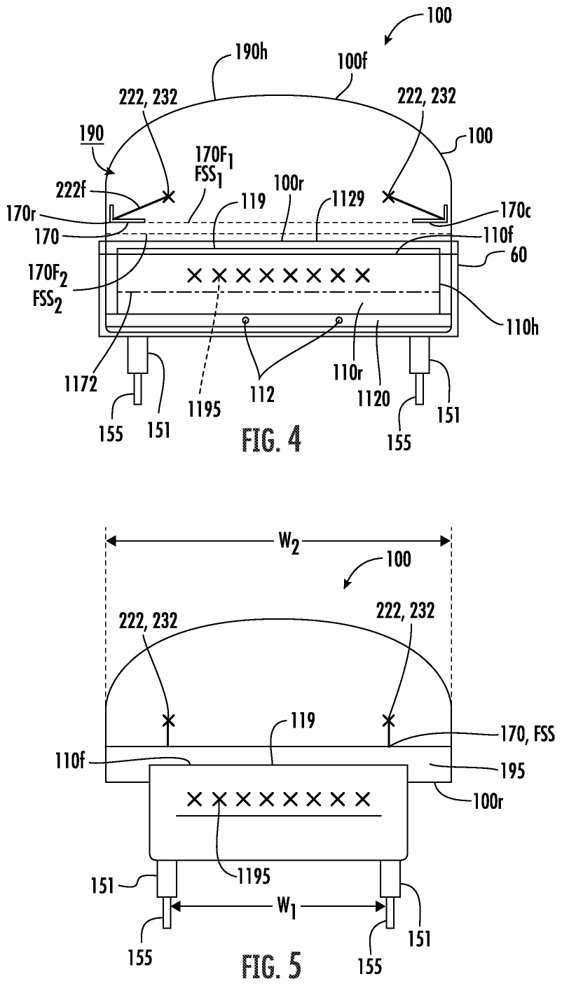

The term “passive antenna assembly” refers to an antenna assembly having arrays of radiating elements that are coupled to radios that are external to the antenna, typically remote radio heads that are mounted in close proximity to the base station antenna 100 or housing 100h. The arrays of radiating elements included in the passive antenna assembly 190 are configured to form static antenna beams. The passive antenna assembly 190 can comprise radiating elements such as one or both low-band radiating elements 222 and/or mid-band or high band radiating elements 232 (see, e.g., FIGS. 4 and 5). The passive antenna assembly 190 is mounted in the base station antenna housing 100h and the base station antenna housing 100h can releasably (detachably) couple (e.g., directly or indirectly attach) to one or more active antenna modules 110 that is/are separate from the passive antenna assembly 190.

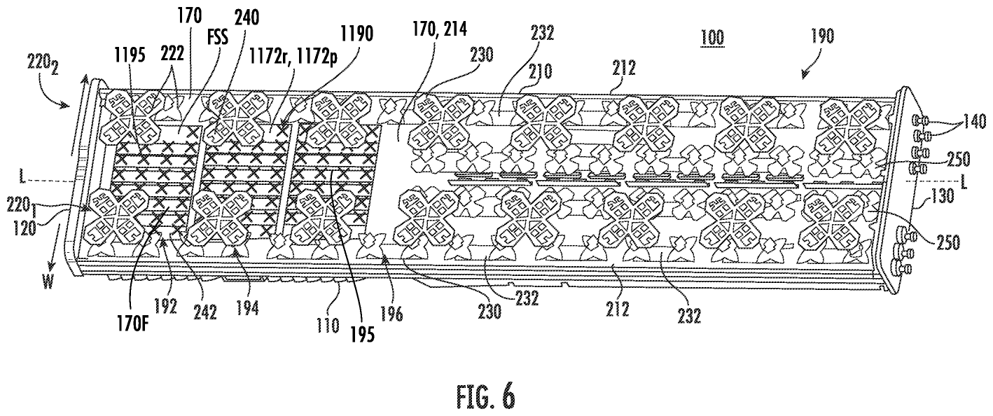

The arrays of radiating elements included in the passive antenna assembly 190 (see, e.g., FIGS. 5 and 6) are configured to form static antenna beams (e.g., antenna beams that are each configured to cover a sector of a base station). The passive antenna assembly 190 may comprise a backplane provided by a reflector 170, with radiating elements 222 projecting in front of the reflector 170 and the radiating elements 222 can include one or more linear arrays of low-band radiating elements that operate in all or part of the 617-960 MHz frequency band and/or one or more linear arrays of mid-band radiating elements that operate in all or part of the 1427-2690 MHz frequency band. The passive antenna assembly 190 (FIG. 3) is mounted in the housing 100h of base station antenna 100 and one or more active antenna modules 110 can releasably (detachably) couple (e.g., directly or indirectly attach) to a back of the base station antenna housing 100h.

Referring to FIG. 3, the base station antenna housing 100h may be substantially rectangular with a flat rectangular cross-section. At least a front side 100f of the housing 100h may be implemented as a radome 111 providing a front radome 111f. A “radome” refers to a dielectric cover that allows RF energy to pass through in certain frequency bands. A rear 100r of the housing 100h may also include a rear radome 111r that is opposite the front radome 111f. Optionally, the housing 100h and/or the radome 111 can also comprise two (narrow) sidewalls 100s providing side radomes 111s facing each other and extending rearwardly between the front radome 111f and the rear radome 111r. The sidewalls 100s, 111s can have a width, measured in a front-to-back direction, that is 40%-90% less than a lateral extent of the housing 100h.

The top side 100t of the housing 100h may be sealed in a waterproof manner and may comprise an end cap 120 and the bottom side 100b of the housing 100h may be sealed with a separate end cap 130 with RF ports 140.

The front side 100f, at least part of the sidewalls 100s and typically at least part of the rear 100r of the housing 100h are typically implemented as radomes that are substantially transparent to RF energy within the operating frequency bands of the passive antenna assembly 190 and active antenna module 110. At least part of the radome 111 may be formed of, for example, fiberglass or plastic.

Radiation (electromagnetic waves) transmitted by the array of radiating elements 1195 (FIGS. 4-6) in the active antenna unit 110 can transmit through a front radome of the active antenna module 110, enter the housing 100h from the back 100r and transmit out the front radome 111f, thus traveling through at least three radome walls spaced apart in a front-to-back direction. Active antenna modules 110 are often configured to operate using time division duplexing multiple access schemes in which the transmit and receive signals do not overlap in time, but instead the active antenna module 110 transmits RF signals during selected time slots and receives RF signals during other time slots. The passive antenna assembly 190 can operate under frequency division duplexing (FDD) multiple access schemes.

Turning to FIG. 3, the mounting system 60 comprises a plurality of mounting brackets 160, 161, 162 that are longitudinally spaced apart and attached to the passive antenna housing 190h and that are also configured to attach to the target mounting structure 130, shown as a pole P. The brackets 160, 161, 162 can be referred to as “passive antenna brackets.” Although shown as three brackets, a lesser number of passive antenna brackets such as two brackets (e.g., brackets 160, 161) may be used or more than three brackets may be used. The mounting system 60 also includes a plurality of brackets 151, 152 that are longitudinally spaced apart and attached to the active antenna module 110 and that are configured to attach directly to the target mounting structure 130. The brackets 151, 152 can be referred to as “active antenna brackets.” The active antenna module 110 can be separately attached to the target mounting structure 130 (independent of the passive antenna housing 190h) using the active antenna brackets 151, 152.

The passive antenna brackets 160, 161, 162 can have mounting arms 160a, 161a, 162a. The active antenna brackets 151, 152 can have mounting arms 151a, 152a. The active antenna mounting arms 151a, 152a, can project rearward a distance D₁. The passive antenna mounting arms 160a, 161a, 162a can rearward forward a distance D₂ which is greater than D₁, whereby D₂>D₁. D₂ can be 1.1-10 times greater than D₁, including 1.5, 2, 2.5, 3, 3.5, 4, 4.5, 5, 5.5, 6, 6.5, 7, 7.5, 8, 8.5, 9, 9.5 and 10 and any number therebetween, or the spacing D₂ can be even greater than 10 times greater than D₁. Each of the brackets 151, 152, 160, 161, 162 can have pole clamps 155. For additional discussion of some brackets for mounting the passive antenna housing 100h, see PCT Application No. PCT/CN2021/11984, the contents of which are hereby incorporated by reference as if recited in full herein.

As shown in FIG. 3, a first one of the passive antenna brackets 160 resides above the active antenna brackets 151, 152 of the active antenna module 110 and two lower passive antenna brackets 161, 162 reside below the active antenna brackets 151, 152. The active antenna module 110 can reside between neighbouring passive antenna brackets 160, 161. The active antenna module 110 can have a width W₁ in a lateral direction that is the same, less or even greater than a width W₂ of the base station antenna housing 100h. FIG. 4 shows the widths Wi being substantially the same as W₂. FIG. 5 shows W₁<W₂ by about 20-80%.

In some embodiments, D₁ may be a fixed distance and D₂ can be adjustable in a front to back direction so that the passive antenna housing 190h can have a first installation position that is forward of a final installation position.

In some embodiments, the passive mounting brackets 160, 161, 162 can have a fixed front to back length D₂ and the active antenna brackets 150, 151 are adjustable to provide an adjustable distance D₁ to allow adjustment in a distance between the active antenna module 110 and the passive antenna housing 100h to thereby position the active antenna module 110 closer to the passive antenna housing 190h after preliminary installation.

In other embodiments, both the active antenna brackets 150, 151 and the passive antenna brackets 160, 161, 162 are adjustable in a front to back direction to adjust D₁ and D₂ and/or the distance between the active antenna module 110 and the passive antenna housing 190h.

In some embodiments, the passive antenna housing 190h can be moved rearward, while attached to the passive antenna brackets 160-163 and the target mounting structure 130 to reside closer to the front 110f of the active antenna unit 110, once attached to the target mounting structure 130. Thus, the rear 100r of the passive antenna housing 100h/190h can abut or be closely spaced apart from the front 110f of the active antenna module 110.

The passive antenna brackets 160, 161, 162 can cooperate to provide an adjustable downtilt of the passive antenna housing 190h. The active antenna brackets 151, 152 can cooperate to provide an adjustable downtilt of the active antenna module 110.

The downtilt of the active antenna module 110 can be adjusted independent of the downtilt of the passive antenna housing 190h.

Once in position on the target mounting structure 130, the active antenna module 110 may optionally be attached to the passive antenna housing 190h.

Referring to FIG. 4, a passive antenna assembly 190 is shown with a reflector 170 in the housing 100h. The reflector 170 can have a frequency selective surface (or FSS) 170F, which can be provided by a printed circuit board/flex circuit or metal grid that extends laterally and longitudinally and can reside in the housing and in front of radiating elements 1195 of the (mMIMO array) of the active antenna module 110 (see, e.g., FIGS. 3 and 4). The frequency selective surface 170F can be provided as first and second frequency selective surfaces 170F₁, 170F₂, stacked in a front-to-back direction to reside in front of the antenna array 1195 of the active antenna module. One of the at least one frequency selective surfaces 170F can reside between longitudinally extending and laterally spaced apart right and left side metal strip reflector segments 170r, 170l.

In some embodiments, the frequency selective surface 170F can be mounted on a suitable substrate such as, for example, a printed circuit board, PC and/or SMC. In some embodiments, the grid pattern is provided by metallic patches in one or more layers over and/or behind one or more dielectric layers, which may be provided by a multiple layer printed circuit board. The frequency selective surface 170F can alternatively be configured as a grid reflector with a grid pattern(s) in sheet metal. For additional discussion of example FSS configurations providing at least part of a reflector, see, e.g., co-pending U.S. patent application Ser. No. 17/787,619 and U.S. Provisional Patent Application Ser. No. 63/359,304, the contents of which are hereby incorporated by reference as if recited in full herein.

The frequency selective surface 170F can be configured to allow high-band radiating elements, typically located in the active antenna module 110, to propagate electromagnetic waves therethrough and to reflect lower band RF signals (lower band electromagnetic waves) from lower band radiating elements 222, 232 (see, e.g., FIGS. 4 and 5) projecting forward of the frequency selective surface 170F.

The frequency selective surface 170F can comprise, in some embodiments, metamaterial, a suitable RF material or even air (although air may require a more complex assembly). The term “metamaterial” refers to composite electromagnetic (EM) materials. Metamaterials may comprise sub-wavelength periodic microstructures.

The rear 100r of the housing 100h may be provided as a closed outer surface, either recessed, or flat as shown in FIGS. 3 and 4. In a final installed configuration, the radome 119 and/or front 110f of the active antenna module 110 can abut or be closely spaced apart from the rear 100r of the housing 190h/100h, such as spaced a distance “d” that is in a range of 0-3 inches or even greater (typically less than 12 inches), such as about 0, about 0.5, about 1.0, about 1.5, about 2 inches, about 2.5 inches or about 3 inches or any number therebetween.

As shown in FIG. 5, the rear 100r of the base station antenna housing 100h can have an open chamber 195 that receives the radome 119 of the active antenna module 110.

Referring to FIG. 4, the active antenna module 110 can have a reflector and/or ground plane 1172 that resides behind the antenna array 1195 in the active antenna module 110. The reflector and/or ground plane 1172 can be configured to galvanically or capacitively couple to the reflector 170 in the base station antenna housing 100h. The reflector 170 in the base station antenna housing 100h can be called “the passive reflector.” The reflector 1172, where used, in the active antenna module 110 can be called “the active reflector.”

Different active antenna modules 110 may be configured to have different radios, radiating elements or other components whereby the active antenna modules 110 can be different for different cellular service providers and even for the same cellular provider. The active antenna module 110 can be interchangeably replaced with another active antenna module 110 from the original equipment manufacturer (OEM) or from the same cellular communications service provider or from different cellular communications service providers. Thus, a plurality of different active antenna modules 110 that have different configurations, including different internal configurations and different external configurations, can be interchangeably used to cooperate with the base station antenna housing 100h. The different active antenna modules 110 can each have the same exterior (perimeter) footprint and connectors or may have different exterior footprints and/or connectors. The different active antenna modules 110 can have different depth dimensions (front to back) and/or different width (lateral) dimensions. A respective base station antenna 100 can, for example, accept different active antenna modules 110 from different service providers at a field installation and/or factory installation site using different adapter members or other mounting configurations that allow the interchangeable field installation/assembly. The base station antenna 100/passive housing 190h/antenna housing 100h can thereby allow different active antenna modules 110 to be interchangeably installed, upgraded, or replaced. The base station antenna 100 can concurrently cooperate with first and second active antenna units 110, one above the other, behind the housing 100h and coupled to the mounting structure 130, in some embodiments.

Referring to FIG. 4, the base station antenna 100 can include a reflector 170 that has right and left side reflector strip segments 170r, 170/(the orientation defined when viewed from a front 100f of the base station antenna 100) that extend in a longitudinal direction, optionally with an open space across at least part of active antenna module 110 and/or with a frequency selective surface 170F in front of the radiating elements 1195 of the active antenna module 110. The reflector 170 can be an extension of or coupled to a primary or main reflector 214 of the passive antenna assembly 190 (FIG. 6).

The base station antenna 100 can include at least one radome positioned between the (passive) reflector 170 and the active antenna module 110. For example, referring to FIG. 4, and as discussed above, the active antenna module 110 can include a radome 119 at a front 110f thereof, that resides in front of a mMIMO antenna array 1195. The passive antenna assembly 190 can include a radome 1129 that resides in front of the radome 119 of the active antenna module 110. The radome 1129 can be defined by a rear wall 100r of the passive antenna housing 190h or provided as another layer/wall.

Thus, in some embodiments, the base station antenna 100 can be configured with a first radome 119 and a second radome 1129, spaced apart in a front to back direction. The first radome 119 can be the front 110f part of the active antenna module 110 and be configured to seal the active antenna module 110. The second radome 1129 can be configured to be a skin or middle/intermediate radome 1129 and can be configured to seal the base station antenna housing 100h comprising the passive antenna assembly 190.

FIG. 4 also illustrates that (the passive antenna assembly 190 of) the base station antenna 100 can include low-band radiating elements 222 with respective angled feed stalks 222f projecting forward of the reflector 170, in front of the active antenna module 110, and extending laterally inward at an angle that is parallel to or that is between 20-80 degrees from horizontal. Note that the low-band radiating elements 222 may (partially) extend in front of the outer columns of high-band radiating elements 1195 of the active antenna module 110. Any of the feed stalk designs disclosed in U.S. Patent Publication No. 201/0305718 (“the '718 publication”) may be used to implement the angled feed stalks 222f. The entire content of the '718 publication is incorporated herein by reference as if set forth in its entirety. However, it is also contemplated that angled feed stalks 222f are not required and conventional configurations of same may be used.

The passive antenna assembly 190 of the base station antenna 100 can include low-band radiating elements 222 and/or mid-band radiating elements 232 with one or more of low-band feed stalks 222f projecting laterally inward from a side segment 170s of the reflector 170 and forward of the reflector 170, in front of the active antenna module 110. Again, note that the low-band radiating elements 222 may (partially) extend in front of the outer columns of high-band (mMIMO) radiating elements 1195 of the active antenna module 110. This configuration may allow improved spacing and/or alternative configurations of the front of the active antenna module 110.

The active antenna module 110 includes radio circuitry. The active antenna module 110 can comprise a radio unit 1120. The active antenna module 110 can also include a filter and calibration printed circuit board assembly, and may also include phase shifters, which may alternatively be part of the filter and calibration assembly. The radiating elements 1195 can be provided as a massive MIMO array. The radiating elements 1195 can project forward of a multi-layer printed circuit board providing a ground plane 1172 and/or defining a reflector 1172.

The radio unit 1120 typically includes radio circuitry that converts base station digital transmission to analog RF signals and vice versa. One or more of the radio units 1120, the antenna assembly or the filter and calibration assembly can be provided as separate sub-units that are attachable (stackable). The radio unit 1120 and the antenna assembly can be provided as an integrated unit, optionally also including the calibration assembly. Where configured as sub-units, different sub-units can be provided by OEMs or cellular service providers while still using a common base station antenna housing 100h and passive antenna assembly 190 thereof.

FIG. 6 is a front view of the passive antenna assembly 190 of base station antenna 100 (with the active antenna module 110 mounted thereon). The active antenna module 110 typically resides entirely behind and external to the rear surface 100r of the base station antenna 100 but can alternatively project forward into a recess 195 provided by the rear surface 100r, optionally with at least one frequency selective surface 170F in front of and over the radiating elements 1195. As shown, the antenna assembly 190 includes a main backplane 210 that has side walls 212 and a main reflector 214. The backplane 210 may serve as both a structural component for the antenna assembly 190 and as a ground plane and reflector for the radiating elements mounted thereon. The backplane 210 may also include brackets or other support structures (not shown) that extend between the side walls 212 along the rear of the backplane 210. Various mechanical and electronic components of the antenna 100 are mounted between the side walls 212 and the back side of the main reflector 214, such as phase shifters, remote electronic tilt units, mechanical linkages, controllers, diplexers, and the like as is well known in the art.

The main backplane 210 defines a main module of the passive antenna assembly 190. The main reflector 214 may comprise a generally flat metallic surface that extends in the longitudinal direction L of the antenna 100. The main reflector 214 can be the (passive) reflector 170 discussed above or can be an extension of, coupled to or different from the (passive) reflector 170 discussed above. If the main reflector 214 is a separate reflector it is (electrically) coupled to the reflector 170 to provide a common electrical ground.

Some of the radiating elements (discussed below) of the antenna 100 may be mounted to extend forwardly from the main reflector 214, and, if dipole-based radiating elements are used, the dipole radiators of these radiating elements may be mounted, for example, approximately ¼ of a wavelength of the operating frequency for each radiating element forwardly of the main reflector 214. The main reflector 214 may serve as a reflector and as a ground plane for the radiating elements of the antenna 100 that are mounted thereon.

Still referring to FIG. 6, the base station antenna 100 can include one or more arrays 220 of low-band radiating elements 222, one or more arrays 230 of first mid-band radiating elements 232, one or more arrays 240 of second mid-band radiating elements 242 and one or more arrays 250 of high-band radiating elements 1195. The arrays 250 can be provided as high band radiating elements for an active array or a mMIMO array in the active antenna module 110. The radiating elements 222, 232, 242, 1195 may each be dual-polarized radiating elements. Further details of radiating elements can be found in co-pending PCT Publication Nos. WO2019/236203 and WO2020/072880, the contents of which are hereby incorporated by reference as if recited in full herein.

The low-band radiating elements 222 are mounted to extend forwardly from the main or primary reflector 214 (and/or the reflector 170) and can be mounted in two columns to form two linear arrays 220 of low-band radiating elements 222. Each low-band linear array 220 may extend along substantially the full length of the antenna 100 in some embodiments.

The low-band radiating elements 222 may be configured to transmit and receive signals in a first frequency band. In some embodiments, the first frequency band may comprise the 617-960 MHz frequency range or a portion thereof (e.g., the 617-896 MHz frequency band, the 696-960 MHz frequency band, etc.). The low-band linear arrays 220 may or may not be used to transmit and receive signals in the same portion of the first frequency band. For example, in one embodiment, the low-band radiating elements 222 in a first linear array 220 may be used to transmit and receive signals in the 700 MHz frequency band and the low-band radiating elements 222 in a second linear array 220 may be used to transmit and receive signals in the 800 MHz frequency band. In other embodiments, the low-band radiating elements 222 in both the first and second linear arrays 220-1, 220-2 may be used to transmit and receive signals in the 700 MHZ (or 800 MHZ) frequency band.

The first mid-band radiating elements 232 may likewise be mounted to extend forwardly from the main reflector 214 and may be mounted in columns to form linear arrays 230 of first mid-band radiating elements 232. The linear arrays 230 of mid-band radiating elements 232 may extend along the respective side edges of the main reflector 214. The first mid-band radiating elements 232 may be configured to transmit and receive signals in a second frequency band. In some embodiments, the second frequency band may comprise the 1427-2690 MHz frequency range or a portion thereof (e.g., the 1710-2200 MHz frequency band, the 2300-2690 MHz frequency band, etc.). In the depicted embodiment, the first mid-band radiating elements 232 are configured to transmit and receive signals in the lower portion of the second frequency band (e.g., some or all of the 1427-2200 MHz frequency band). The linear arrays 230 of first mid-band radiating elements 232 may be configured to transmit and receive signals in the same portion of the second frequency band or in different portions of the second frequency band and may extend substantially the full length of the antenna 100 in some embodiments.

The second mid-band radiating elements 242 can be mounted in columns in the lower medial portion of antenna 100 to form linear arrays 240 of second mid-band radiating elements 242. The second mid-band radiating elements 242 may be configured to transmit and receive signals in the second frequency band. In the depicted embodiment, the second mid-band radiating elements 242 are configured to transmit and receive signals in an upper portion of the second frequency band (e.g., some, or all, of the 2300-2700 MHz frequency band). In the depicted embodiment, the second mid-band radiating elements 242 may have a different design than the first mid-band radiating elements 232.

The high-band radiating elements 1195 can be mounted in columns in the upper medial or center portion of the active antenna module 110 and/or the base station antenna 100 to form (e.g., four) linear arrays 250 of high-band radiating elements. The high-band radiating elements 1195 may be configured to transmit and receive signals in a third frequency band. In some embodiments, the third frequency band may comprise the 3300-4200 MHz frequency range or a portion thereof. The high band radiating elements 1195 can reside behind or extend into a recess 155 in the reflector 170 or behind a frequency selective surface that extends across the space depicted by the recess in FIG. 4.

In the depicted embodiment, the arrays 220 of low-band radiating elements 222, the arrays 230 of first mid-band radiating elements 232, and the arrays 240 of second mid-band radiating elements 242 are all part of the passive antenna assembly 190, while the arrays 250 of high-band radiating elements 1195 are part of the active antenna module 110. It will be appreciated that the types of arrays included in the passive antenna assembly 190, and/or the active antenna module 110 may be varied in other embodiments.

It will also be appreciated that the number of linear arrays of low-band, mid-band and high-band radiating elements may be varied from what is shown in the figures. For example, the number of linear arrays of each type of radiating elements may be varied from what is shown, some types of linear arrays may be omitted and/or other types of arrays may be added, the number of radiating elements per array may be varied from what is shown, and/or the arrays may be arranged differently. As one specific example, the two linear arrays 240 of second mid-band radiating elements 242 may be replaced with four linear arrays of ultra-high-band radiating elements that transmit and receive signals in a 5 GHz frequency band.

The low-band and mid-band radiating elements 222, 232, 242 may each be mounted to extend forwardly of and/or from the main reflector 214.

Each array 220 of low-band radiating elements 222 may be used to form a pair of antenna beams, namely an antenna beam for each of the two polarizations at which the dual-polarized radiating elements are designed to transmit and receive RF signals. Likewise, each array 232 of first mid-band radiating elements 232, and each array 242 of second mid-band radiating elements 242 may be configured to form a pair of antenna beams, namely an antenna beam for each of the two polarizations at which the dual-polarized radiating elements are designed to transmit and receive RF signals. Each linear array 220, 230, 240 may be configured to provide service to a sector of a base station. For example, each linear array 220, 230, 240 may be configured to provide coverage to approximately 120° in the azimuth plane so that the base station antenna 100 may act as a sector antenna for a three-sector base station. Of course, it will be appreciated that the linear arrays may be configured to provide coverage over different azimuth beamwidths. While all of the radiating elements 222, 232, 242, 1195 are dual-polarized radiating elements in the depicted embodiments, it will be appreciated that in other embodiments some or all of the dual-polarized radiating elements may be replaced with single-polarized radiating elements. It will also be appreciated that while the radiating elements are illustrated as dipole radiating elements in the depicted embodiment, other types of radiating elements such as, for example, patch radiating elements may be used in other embodiments.

Some or all of the radiating elements 222, 232, 242, 1195 may be mounted on feed boards that couple RF signals to and from the individual radiating elements 222, 232, 242, 1195, with one or more radiating elements 222, 232, 242, 1195 mounted on each feed board. Cables (not shown) and/or connectors may be used to connect each feed board to other components of the antenna 100 such as diplexers, phase shifters, calibration boards or the like.

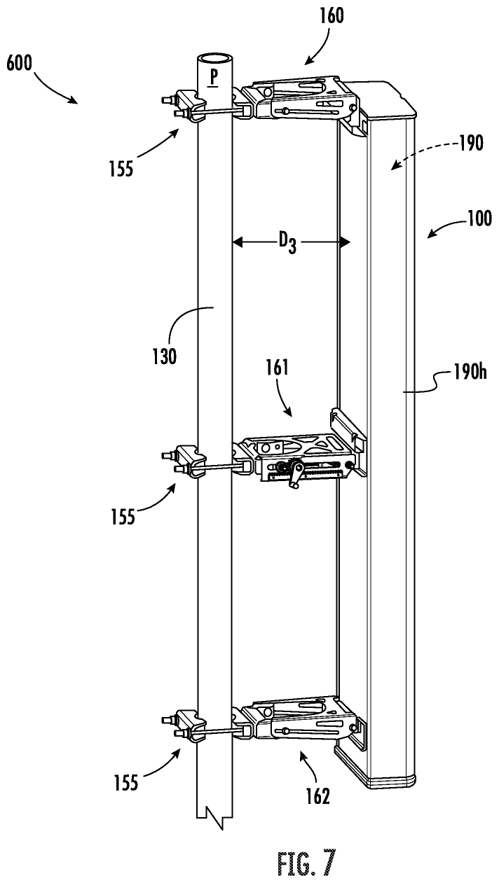

Referring now to FIGS. 7-12C, mounting systems 60, 600 and their tilt adjustment capabilities according to embodiments of the present invention will now be described in further detail. Properties and/or features of the mounting system 600 may be as described above in reference to the mounting system 60 shown in FIG. 3 and duplicate discussion thereof may be omitted herein for the purposes of discussing FIGS. 7-12C.

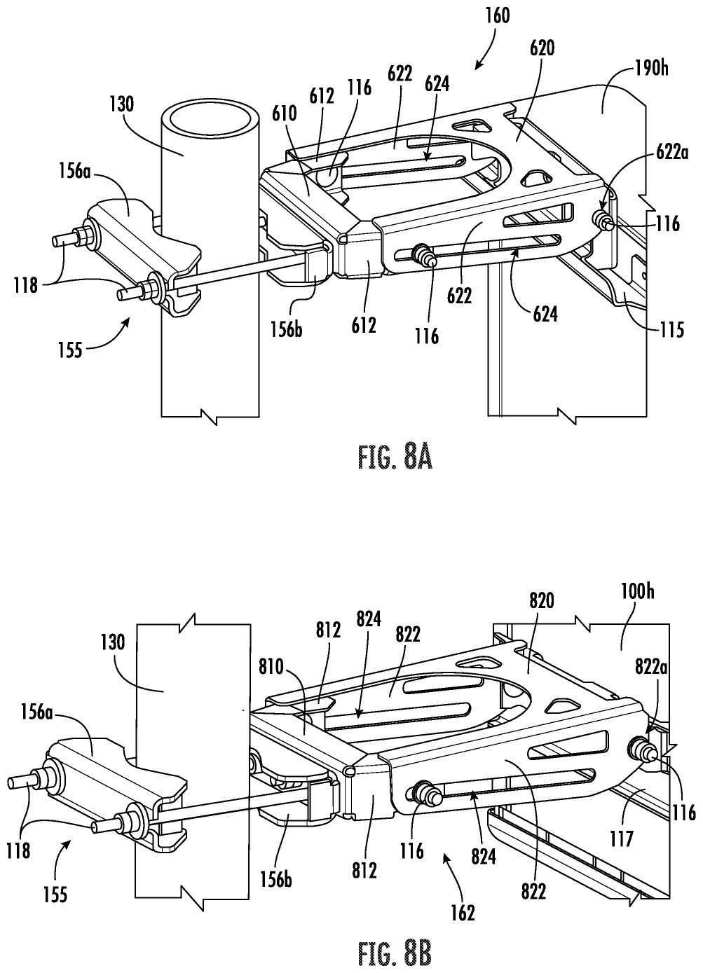

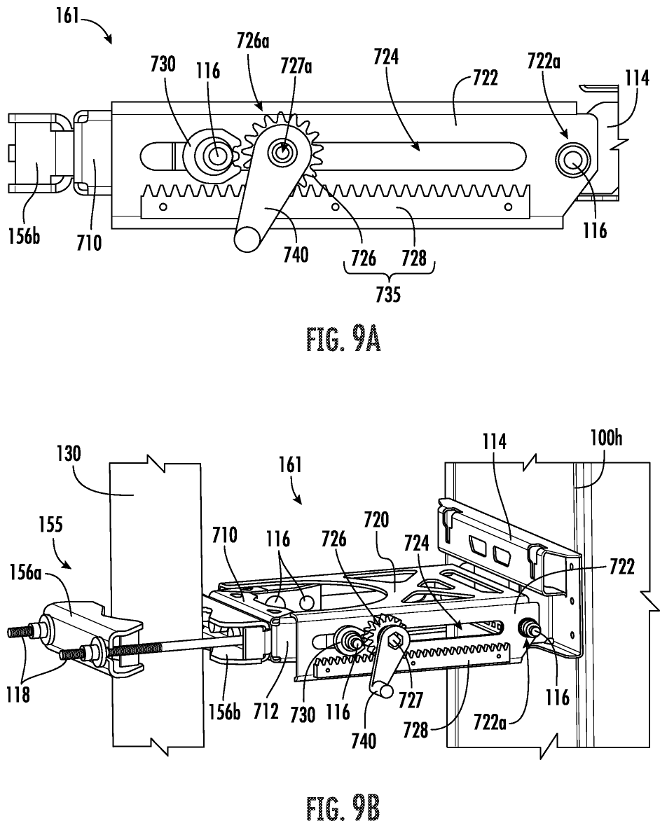

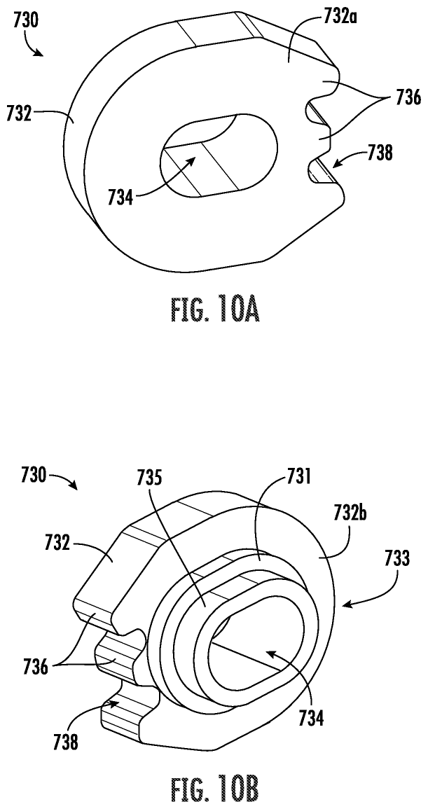

Referring to FIG. 7, the mounting system 600 according to embodiments of the present invention is illustrated (see also, e.g., FIGS. 10A-10C, FIG. 11A, FIG. 12A). The mounting system 600 is similar to the mounting system 60 described herein, except that an active antenna module (remote radio unit (RRU) or radio) 110 is not included. As shown in FIG. 7, the mounting system 600 comprises a plurality of mounting brackets 160, 161, 162 that are longitudinally spaced apart and attached to the antenna housing 190h. The mounting brackets 160, 161, 162 are also configured to be attach to a mounting structure 130, shown as a pole P. These brackets 160, 161, 162 can be referred to as “antenna brackets” or “passive antenna brackets.” As noted herein, although shown as three brackets, a lesser number of antenna brackets such as two brackets (e.g., brackets 160, 161) may be used or more than three brackets may be used. These brackets 160, 161, 162 will be described in further detail below with reference to FIGS. 8A-8B and FIG. 9A-9B.

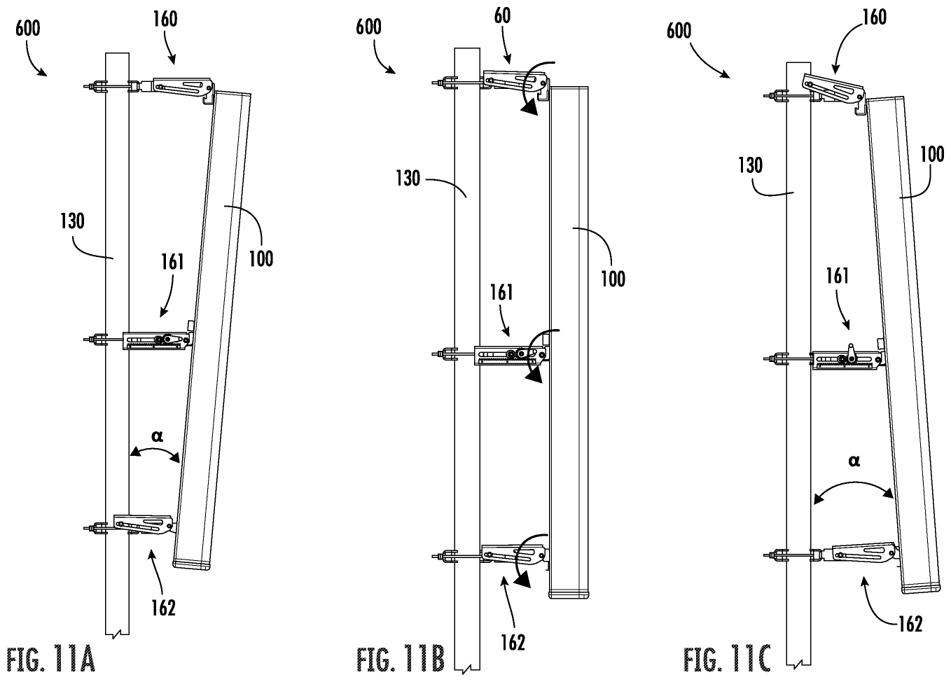

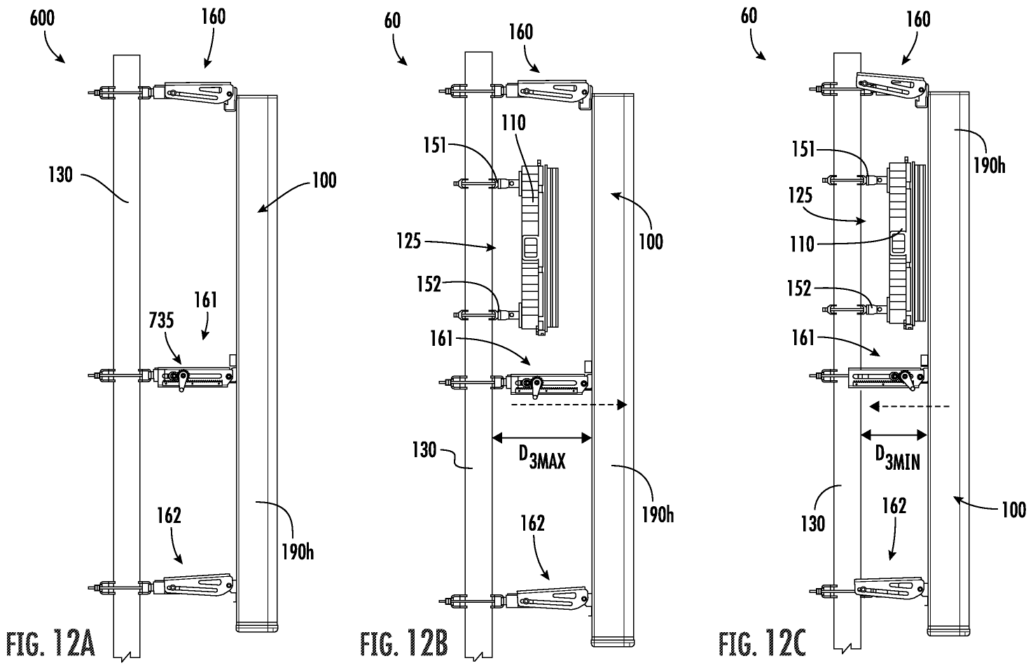

In some embodiments, as shown in FIGS. 11B-11C and FIGS. 12B-12C, the mounting system 60 further includes a mounting kit 125 comprising a plurality of brackets 151, 152 that are longitudinally spaced apart and attached to the active antenna module 110. These brackets 151, 152 are also configured to attach directly to the mounting structure 130 (see also, e.g., FIG. 3). These brackets 151, 152 can be referred to as “radio brackets” or “active antenna brackets.” The active antenna module 110 can be separately attached to the target mounting structure 130 (independent of the antenna housing 190h) using the active antenna brackets 151, 152. Each of the brackets 151, 152, 160, 161, 162 can be coupled to a respective pole (or pipe) clamp 155 that mounts and secures the respective brackets 151, 152, 160, 161, 162 to the mounting structure 130.

Referring to FIG. 8A, the upper passive antenna bracket 160 according to embodiments of the present invention is illustrated. As shown in FIG. 8A, one end of the upper passive antenna bracket 160 is configured to be mounted and secured to the mounting structure 130 (e.g., via a pipe clamp 155) and the opposing end of the upper passive antenna bracket 160 is configured to be mounted and secured to an upper portion of the passive antenna housing 190h (e.g., via an upper antenna mount bracket 115).

The upper passive antenna bracket 160 includes a main body 620 having two opposing sidewalls 622 that are coupled to and extend downwardly therefrom. In some embodiments, the upper passive antenna bracket 160 further includes an extension member 610 coupled to the opposing sidewalls 622 and secured to a clamping member 156b of the pipe clamp 155. Each sidewall 622 comprises an aperture 622a configured to receive a respective fastener 116 such that the upper passive antenna bracket 160 can be pivotably mounted and secured to the upper antenna mount bracket 115.

Each sidewall 622 further comprises an elongated slot 624 configured to receive a respective fastener 116. In some embodiments, the fastener 116 received through the slot 624 secures the upper passive antenna bracket 160 to the pipe clamp 155 or extension member 610. As shown in FIG. 8A, in some embodiments, the fasteners 116 secure the opposing sidewalls 622 to respective arms 612 of the extension member 610. As discussed in further detail below, the fasteners 116 are configured to slide within their respective elongated slots 624 as the passive antenna housing 190h is moved (e.g., pushed or pulled) in relation to the mounting structure 130 (e.g., to adjust the angle of tilt downward or upward).

Referring to FIG. 8B, the lower passive antenna bracket 162 according to embodiments of the present invention is illustrated. The lower passive antenna bracket 162 is the same or similar to the upper passive antenna bracket 160. As shown in FIG. 8B, one end of the lower passive antenna bracket 162 is configured to be mounted and secured to the mounting structure 130 (e.g., via a pipe clamp 155) and the opposing end of the lower passive antenna bracket 162 is configured to be mounted and secured to a lower portion of the passive antenna housing 190h (e.g., via a lower antenna mount bracket 117).

Like the upper passive antenna bracket 160, the lower passive antenna bracket 162 includes a main body 820 having two opposing sidewalls 822 that are coupled to and extend downwardly therefrom. In some embodiments, the lower passive antenna bracket 162 further includes an extension member 810 coupled to the opposing sidewalls 822 and secured to a clamping member 156b of the pipe clamp 155. Each sidewall 822 comprises an aperture 822a configured to receive a respective fastener 116 such that the lower passive antenna bracket 162 can be pivotably mounted and secured to the lower antenna mount bracket 117.

Each sidewall 822 further comprises an elongated slot 824 configured to receive a respective fastener 116. In some embodiments, the fastener 116 received through the slot 824 secures the lower passive antenna bracket 162 to the pipe clamp 155 or extension member 810. As shown in FIG. 8B, in some embodiments, the fasteners 116 secure the opposing sidewalls 822 to respective arms 812 of the extension member 810. The fasteners 116 are configured to slide within their respective elongated slots 824 as the passive antenna housing 190h is moved (e.g., pushed or pulled) in relation to the mounting structure 130 (e.g., to adjust the angle of tilt downward or upward).

Referring now to FIGS. 9A-9B, the middle passive antenna bracket 161 according to embodiments of the present invention is illustrated. As shown in FIGS. 9A-9B, the middle passive antenna bracket 161 includes a main body 720 having two opposing sidewalls 722 that are coupled to and extend downwardly therefrom. Each sidewall 722 comprises an elongated slot 724. In some embodiments, the middle passive antenna bracket 161 further includes an extension member 710 coupled to the opposing sidewalls 722 and secured to a clamping member 156b of the pipe clamp 155. In some embodiments, the extension member 710 comprises opposing arm members 712 extending outwardly therefrom. As shown in FIG. 9B, in some embodiments, each sidewalls 722 of the middle passive antenna bracket 161 may be coupled and/or secured to a respective arm member 712 of the extension member 710.

Still referring to FIGS. 9A-9B, the middle passive antenna bracket 161 further comprises a rack and pinion assembly 735 (i.e., rack 728 and pinion 726). The rack 728 is coupled to an outer surface of one of the sidewalls 722. The pinion 726 has a plurality of teeth 726a configured to engage the rack 728 and is secured the bracket 161 via a fastener 729. In some embodiments, the fastener 729 extends through the elongated slot 724 in the corresponding sidewall 202 and may be secured to the extension member 710 or clamping member 156b. The fastener 729 holds the pinion 726 against an outer surface of the sidewall 722 and is configured to allow the pinion 726 to rotate relative to the sidewall 722 such that the pinion 726 can travel back-and-forth along the rack 728. As described in further detail below, the rack and pinion assembly 735 is used to adjust the antenna housing 190h to a desired distance (D₃) from the mounting structure 130 (see, e.g., FIG. 7).

In some embodiments, an end 727a of the fastener 727 may be configured to engage a wrench 740 which may be used by a technician to rotate the pinion 726 to adjust the distance (D₃) between the mounting structure 130 and the passive antenna housing 190h. For example, the end 209a of the fastener 209 may be keyed to engage a hex wrench.

In some embodiments, the middle passive antenna bracket 161 may further comprise a brake slider 730 (see also, e.g., FIGS. 10A-10B). The brake slider 730 is configured to engage the pinion 726 to lock the pinion 726 in position (e.g., when the antenna housing 190h has been moved a desired distance (D₃) in relation to the mounting structure 130). In some embodiments, the brake slider 730 may be secured to the extension member an arm member 712 of the extension member 710 via a respective fastener 116. The fastener 116 for the brake slider 730 extends through the same elongated slot 724 in the sidewall 722 of the bracket 161 as the fastener 727 holding the pinion 726.

As shown in FIGS. 10A-10B, in some embodiments, the brake slider 730 has a main body 732 having opposing sides 732a, 732b. An oval-shaped aperture 734 extends through the main body 732. An edge of the brake slider 730 has a plurality of protrusions 736 and recesses 738 (e.g., teeth). The teeth of the brake slider 730 are configured to engage the teeth 726a of the pinion 726. In some embodiments, one side 732a of the main body 732 of the brake slider 730 may be substantially planar (e.g., flat). In some embodiments, the opposing side 732b may have a protruding section 733 that extends outwardly therefrom. In some embodiments, the protruding section 733 has a shoulder 731.

In some embodiments, the protruding section 733 of the brake slider 730 is configured to be received by the elongated slot 724 of the bracket 161. An outer surface 735 of the protruding section 733 is configured to slide against an inner surface of the elongated slot 724. The shoulder 731 of the protruding section 733 contacts an outer surface of the sidewall 722 of the bracket 161 creating a gap between the main body 732 of the brake slider 730 and the sidewall 722 of the bracket 161. In some embodiments, the gap helps align the “teeth” of the brake slider 730 (i.e., protrusions 736 and recesses 738) with the teeth 726a of the pinion 726.

The elliptical-shaped aperture 734 allows the brake slider 730 to slide back-and-forth relative to the fastener 116. This movement allows the brake slider 730 to engage or disengage the pinion 726. When the brake slider 730 is disengaged from the pinion 726, the pinion 726 is able to rotate relative to the sidewall 722 of the bracket 161 (i.e., the brake slider 730 is in an “unlocked” position). When the brake slider 730 is engaged with the pinion 726, the pinion 726 is prevented from rotating relative to the sidewall 722 of the bracket 161 (i.e., the brake slider 730 is in a “locked” position).

Referring back to FIGS. 9A-9B, each sidewall 722 of the bracket 161 further comprises a plurality of apertures 722a that are configured to receive respective fasteners 116. As shown in FIGS. 9A-9B, at least two of the apertures 722a are configured to receive a respective fastener 116 for pivotably mounting and securing a middle antenna mounting bracket 114 (and antenna housing 190h attached thereto) to the middle antenna bracket 161.

In operation, and shown in FIGS. 11A-11C, the mounting system 600 may be configured to tilt the base station antenna 100 upwardly or downwardly to a desired angle of tilt (a). FIG. 11A shows the mounting system 600 providing a downward tilt to the base station antenna 100 (e.g., a downward angle of tilt (a) at about 5 degrees). FIG. 11B shows the mounting system 600 providing zero tilt to the base station antenna 100. FIG. 11C shows the mounting system 600 providing an upward tilt to the base station antenna 100 (e.g., an upward angle of tilt (a) at about 5 degrees). The arrows in FIG. 11B show that the base station antenna 100 is configured to move (e.g., pivot) relative to the respective passive antenna brackets 160, 161, 162 (e.g., pivot about the fasteners securing the antenna mounting brackets 114, 115, 117) to adjust the base station antenna 100 to a desired angle of tilt (a).

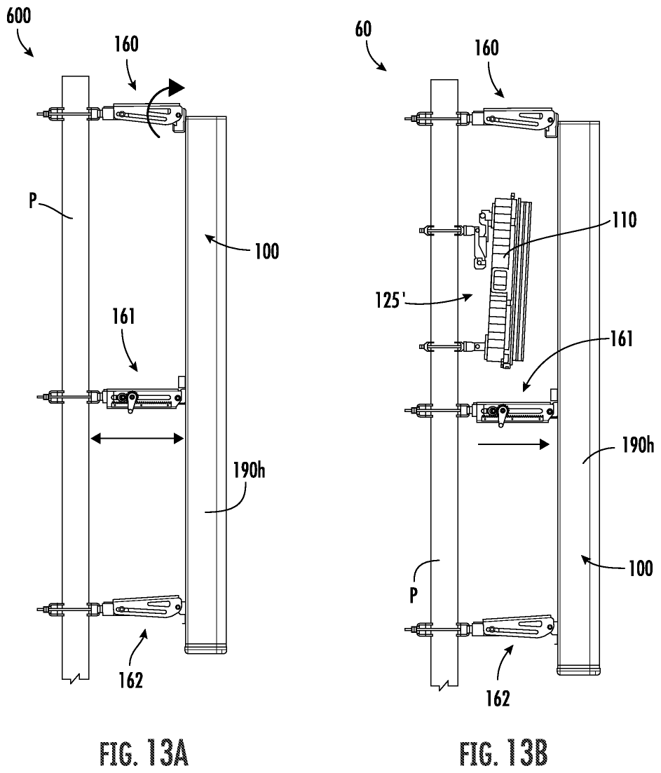

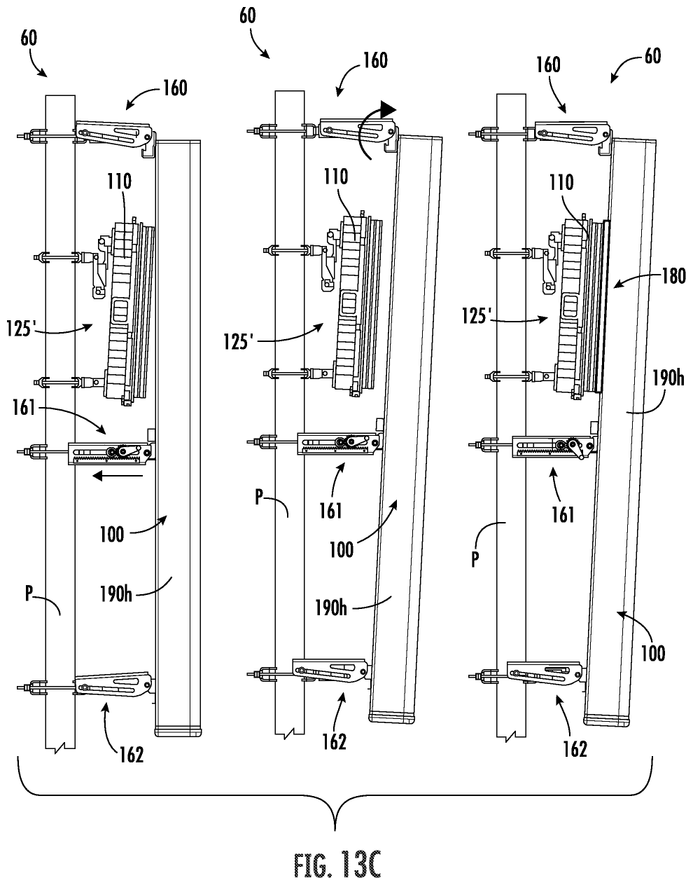

To adjust the angle of tilt (a), a technician engages a wrench 740 (or other similar device) with the rack and pinion assembly 735 of the middle passive antenna bracket 161 (e.g., engages the wrench 740 with the end 727a of a fastener 727 of the pinion 726) (see, e.g., FIGS. 9A-9B). The technician then moves/slides the brake slider 730 to disengage the pinion 726, thereby allowing the pinion 726 to rotate relative to the sidewall 722 of the bracket 161 and travel back-and-forth along the rack 728. The technician rotates the pinion 726 to travel a desired direction along the rack 728 which simultaneously moves the bracket 161 forwardly or rearwardly relative to the pipe clamp 155 (and extension member 710 coupled thereto) and mounting structure 130 (see also, e.g., FIGS. 12A-12C and FIGS. 13A-13C).

As the bracket 161 moves in response to the rotation of the pinion 726, the passive antenna housing 190h moves forwardly or rearwardly (i.e., toward or away from the mounting structure 130). For example, in some embodiments, rotation of the pinion 726 in a clockwise direction may move the bracket 161 (and passive antenna housing 190h) rearwardly relative to the mounting structure 130 (i.e., toward the mounting structure 130) (see, e.g., FIG. 12C). In some embodiments, rotation of the pinion 726 in a counterclockwise direction may move the bracket 161 (and passive antenna housing 190h) forwardly relative to the mounting structure 130 (i.e., away from the mounting structure 130) (see, e.g., FIG. 12B). The brake slider 730 may then be moved or slid to engage the pinion 726, thereby locking the mounting system 600 and base station antenna 100 (i.e., passive antenna housing 190h) at the desired distance (D₃) from the mounting structure 130 (see, e.g., FIG. 7).

Once positioned at the desired distance (D₃) from the mounting structure 130, the base station antenna 100 can be adjusted to the desired angle of tilt (α). As noted above, the passive antenna housing 190h (and base station antenna 100) is pivotably mounted to the middle passive antenna bracket 161 (i.e., pivots about the fasteners 116 securing the middle antenna mounting bracket 114 to the middle passive antenna bracket 161) which allows the base station antenna 100 to be adjusted to desired angle of tilt (α).

As shown in FIG. 11A, to provide downtilt to the base station antenna 100, the upper passive antenna bracket 160 allows the upper portion of passive antenna housing 190h to move in a direction away from the mounting structure 130 (i.e., via the fastener 116 sliding within the elongated slot 624 and pivoting about the fastener 116 securing the upper passive antenna bracket 160 to the upper antenna mounting bracket 115). In response, the lower passive antenna bracket 162 allows the lower portion of the passive antenna housing 190h to move in a direction toward the mounting structure 130 (i.e., via the fastener 116 sliding within the elongated slot 824 and pivoting about the fastener 116 securing the lower passive antenna bracket 162 to the lower antenna mounting bracket 117). The passive antenna housing 190h pivots about the middle passive antenna bracket 161 as the upper and lower portions of the passive antenna housing 190h move in opposite directions until a desired downtilt of the base station antenna 100 has been achieved.

As shown in FIG. 11C, to provide uptilt to the base station antenna 100, the upper portion of passive antenna housing 190h is moved in a direction toward the mounting structure 130. In response, the lower passive antenna bracket 162 allows the lower portion of the passive antenna housing 190h to move in a direction away the mounting structure 130. The passive antenna housing 190h pivots about the middle passive antenna bracket 161 as the upper and lower portions of the passive antenna housing 190h move in opposite directions until a desired uptilt of the base station antenna 100 has been achieved.

FIGS. 12A-12C and FIGS. 13A-13C illustrate how the mounting system 60, 600 is configured to adjust the distance (D₃) that base station antenna 100 (antenna housing 190h) is from the mounting structure 130 in order to accommodate the mounting of an active antenna module (radio) 110 to the mounting structure (FIGS. 12A-12C) as well as also being configured such that the angle of tilt (α) of the base station antenna 100 may be adjusted after the active antenna module 110 has been mounted to the mounting structure 130 behind the base station antenna 100 (i.e., the antenna housing 190h) (FIGS. 13A-13C).

As discussed above, FIG. 12A further illustrates how the middle passive antenna bracket 161 is configured to move the base station antenna 100 (i.e., the passive antenna housing 190h) back-and-forth a distance (D₃) relative to the mounting structure 130 (via the rack and pinion assembly 735).

As shown in FIG. 12B, to install (mount) an active antenna module 110 to the mounting structure 130 behind the already-mounted passive antenna housing 190h, first the mounting system 60, 600 (i.e., the middle passive antenna bracket 161) moves the passive antenna housing 190h a maximum distance (D_{3MAX}) from the mounting structure 130. This provides additional space between the mounting structure 130 and the passive antenna housing 190h which allows a technician to more easily mount the active antenna module 110 to the mounting structure 130 (via mounting kit 125 including mounting brackets 151, 152) behind the passive antenna housing 190h. As shown in FIG. 12C, after the active antenna module 110 has been secured to the mounting structure 130, the mounting system 60, 600) (i.e., the middle passive antenna bracket 161) moves the passive antenna housing 190h a minimum distance (D_{3MIN}) from the mounting structure 130 which is proximate to the active antenna module 110. In some embodiments, a gauge 180 may be placed between the active antenna module 110 and the passive antenna housing 190h to prevent the passive antenna housing 190h from contacting the mounted active antenna module 110) (see, e.g., FIG. 13C).

In some embodiments, as shown in FIGS. 13A-13C, the active antenna module 110 may be secured to the mounting structure 130 via an alternative mounting kit 125′ that is configured to provide downtilt to the active antenna module 110. After the active antenna module 110 is mounted to the mounting structure 130 by mounting kit 125′, the mounting system 60 is configured move both the passive antenna housing 190h (and base station antenna 100) relative to the mounting structure 130 and configured to tilt the passive antenna housing 190h (and base station antenna 100) to accommodate the tilt of the active antenna module 110, as previously described herein.

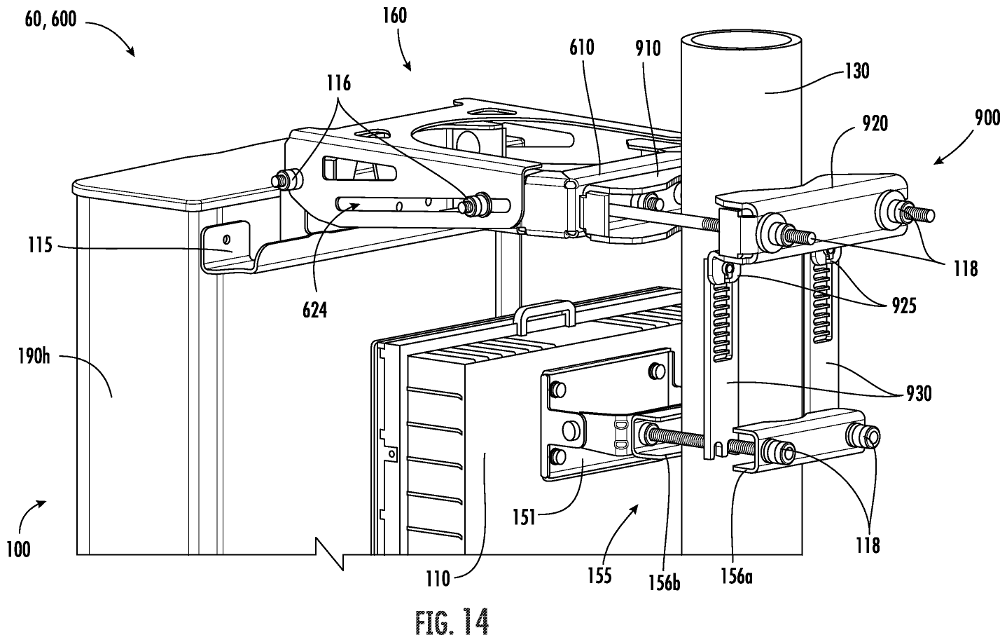

Referring now to FIGS. 14-16B, a mounting gauge kit 900 according to embodiments of the present invention is illustrated. As shown in FIG. 14, the mounting gauge kit 900 may be used with the mounting systems 60, 600 described herein. The mounting gauge kit 900 is configured to define a relative location for the mounting system 60, 600 and the active antenna module (radio) 110. Specifically, the mounting gauge kit 900 is configured to define the location of an upper pipe clamp 155 for the active antenna module (radio) 110 along the mounting structure 130 in relation to the upper passive antenna bracket 160 of the mounting system 60, 600.

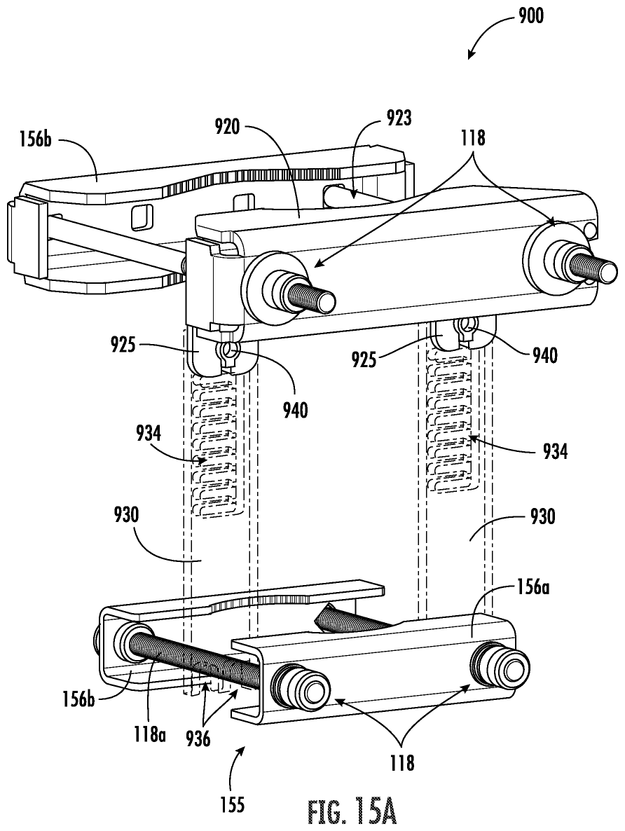

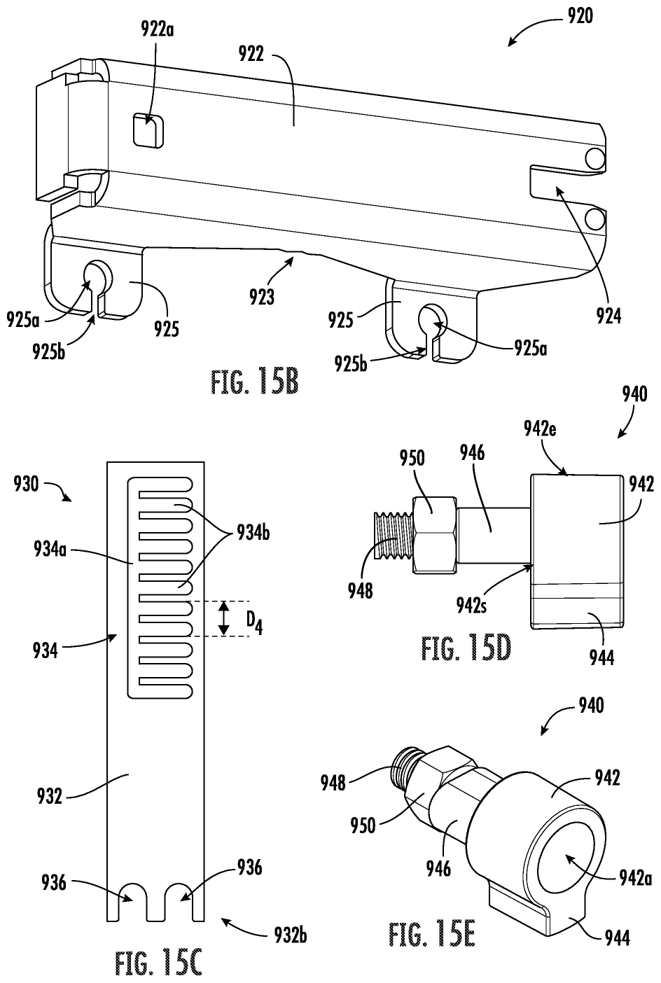

The mounting gauge kit 900 is also illustrated in FIG. 15A. As shown in FIG. 14 and FIG. 15A, the mounting gauge kit 900 comprises two gauge plates 930 (see also FIG. 15C). As described in further detail below, according to embodiments of the present invention, each gauge plate 930 is configured to be secured to a modified clamping member 920 of the pipe clamp 155 coupled to the upper passive antenna bracket 160. In addition, a bottom end 932b of each gauge plate 930 is configured to engage a respective rod or bolt 118a of the upper pipe clamp 155 coupled to the active antenna module 110.

The modified clamping member 920 is illustrated in FIG. 15B. The modified clamping member 920 has a main body 922 having a pair of recesses 923. The modified clamping member 920 is configured to be coupled to an opposing clamping member 156b via a pair of fasteners 118 (see, e.g., FIG. 14 and FIG. 15A). The opposing clamping member 156b is coupled to the upper passive antenna bracket 160, as described herein (see, e.g., FIG. 8A, FIG. 14, and FIG. 15A). One of the fasteners 118 is configured to be received through an aperture 922a in the main body 922 of the modified clamping member 920. In some embodiments, the main body 922 further comprises an open-ended slot 924 configured to receive the second fastener 118. In some embodiments, the main body 922 may comprise a second aperture 922a in place of the open-ended slot 924. As the fasteners 118 are tightened, the clamping members 156b, 920 are pulled together to secure the mounting structure 130 therebetween. The recesses 923 of the clamping member 920 are configured to receive at least a portion of the mounting structure 130 to help further secure the mounting structure 130 therebetween.

The modified clamping member 920 further comprises a pair of flanges 925 extending downwardly from the main body 922. Each flange 925 is configured to affix a respective gauge plate 930 to the clamping member 920. As shown in FIG. 15B, in some embodiments, each flange 925 comprises an open-ended slot 925b extending into an aperture 925a. As discussed in further detail below, the apertures 925a and slots 925b are configured to receive and secure a respective cap bolt 940 therein.

Referring to FIG. 15C, one of the gauge plates 930 is illustrated. Each gauge plate 930 is identical, and thus, any details of one gauge plate 930 described herein are applicable to both gauge plates 930. As shown in FIG. 15C, the gauge plate 930 comprises a generally rectangular main body 932. A lower edge 932b of the main body 932 comprises one or more recesses 936. The recesses 936 are configured to receive a respective rod or bolt 118a of the upper pipe clamp 155 that is coupled to the active antenna module 110 (see FIG. 15A). Having more than one recess 936 in the gauge plate 930 allows the gauge plate 930 to be used on mounting structures 130 (e.g., mounting pipes P) having different diameters (i.e., different distances between the fasteners 118a.

The main body 932 of the gauge plate 930 further comprises one or more apertures 934. As shown in FIG. 15C, in some embodiments, the one or more apertures 934 include a vertically-extending elongated aperture 934a and a series of horizontally-extending apertures 934b. Each of the horizontally-extending apertures 934b extend outwardly from the vertically-extending elongated aperture 934a such that the horizontally-extending apertures 934b are generally perpendicular to the vertically-extending aperture 934a and generally parallel to each other. In some embodiments, the horizontally-extending apertures are spaced apart a distance (D₄) in a range of about 6 mm to about 12 mm, and typically about 9 mm. The distance between the active antenna module 110 and the upper passive antenna bracket 160 will vary depending on the size of the active antenna module 110 and/or passive antenna housing 190h. As discussed in further detail below, each horizontally-extending aperture 934b is in fluid communication with the vertically-extending aperture 934a such that at least a portion of a cap bolt 940 can traverse within one of the horizontally-extending apertures 934b into the vertically-extending aperture 934a, and then back into a different horizontally-extending apertures 934b without having to be removed from the gauge plate 930. The horizontally-extending apertures 934b correspond to a defined location to secure the active antenna module 110 mounting kit (i.e., a location for the upper pipe clamp 155 for the active antenna module (remote radio unit) 110 along the mounting structure 130 in relation to the upper passive antenna bracket 160 of the mounting system 60, 600).

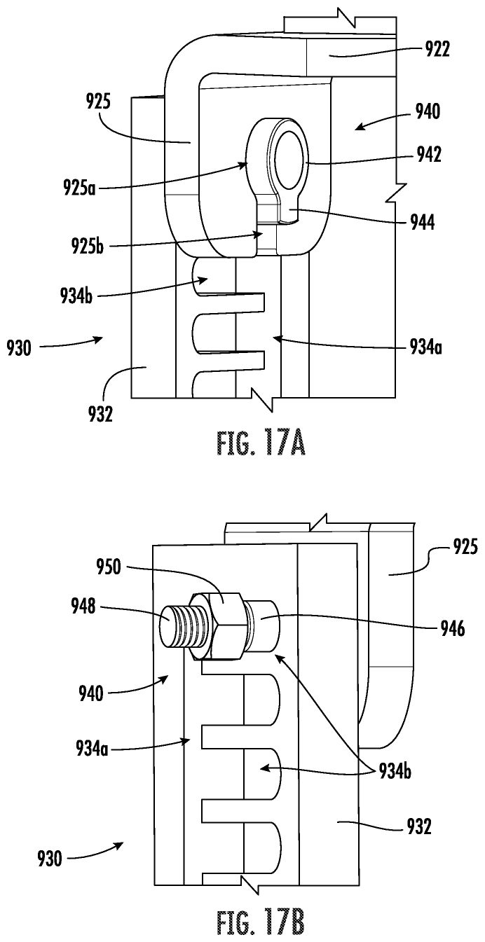

The mounting kit 900 further comprises two fastening mechanisms. In some embodiments, the fastening mechanism comprise a cap bolt 940 and corresponding nut 950. One of the cap bolts 940 is illustrated in FIGS. 15D-15E. As noted above, each cap bolt 940 is configured to be received through a respective aperture 925a in the modified clamping member 920. At least a portion of each cap bolt 940 is also configured to be received through the apertures 934 of a respective gauge plate 930 (see also FIGS. 17A-17B).

As shown in FIGS. 15D-15E, each cap bolt 940 has a main body 942, a transition section 946, and a threaded end 948. In some embodiments, the main body 942 has a generally cylindrical profile with a locking section 944 extending radially outwardly therefrom. The cylindrical main body 942 is configured to be received through the aperture 925a of a respective flange 925 of the modified clamping member 920 and the locking section 944 is configured to be received by the corresponding open-ended slot 925b (see also, FIG. 17A). In some embodiments, a top edge 942e of the main body 942 has a slight draft or taper. For example, in some embodiments, the top edge 942e of the main body 942 has a draft of about 1 degree. The draft degree of the cap bolt 940 may help a technician more easily fix the gauge plate 930 to the clamping member 920. In some embodiments, one end of the main body 942 may also comprise a recess 942a for weight reduction.

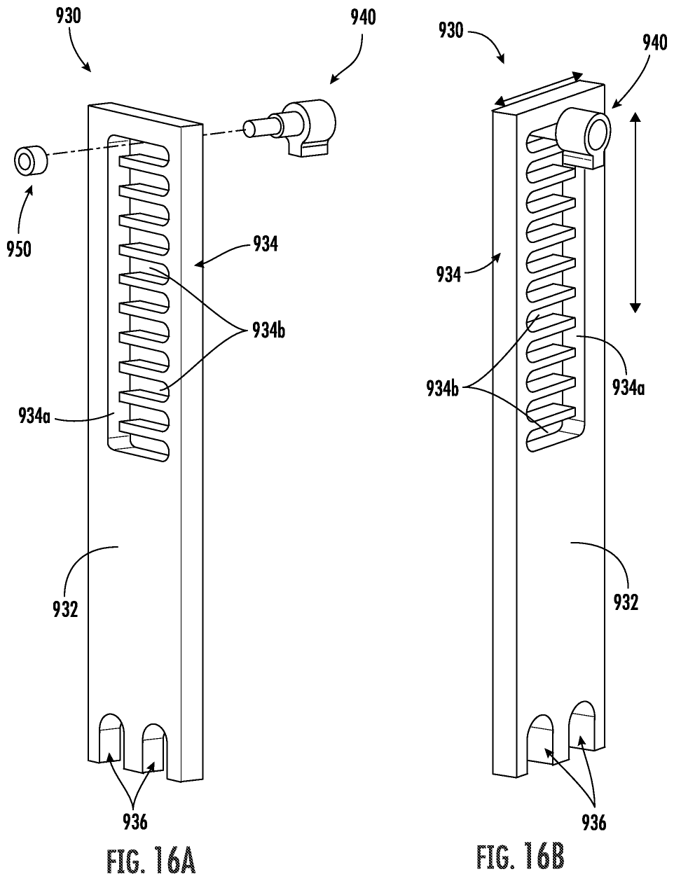

The transition section 946 is integral with or coupled to the main body 942 and extends outwardly from one end of the main body 942 (i.e., extending outwardly from the opposing end having the recess 942a) and defines a shoulder 942s between the main body 942 and the transition section 946. The transition section 946 is sized and configured to be received by the horizontally-extending apertures 934b in the gauge plate 930 (see also, FIGS. 16A-16B and FIG. 17B). When the transition section 946 is received within a respective aperture 934b the transition section 946 is configured to traverse and slide within the apertures 934b. When a technician inserts the cap bolt 940 into an aperture 934b of the gauge plate 930, the shoulder 942s provides a stop point which prevents the technician from inserting the cap bolt 940 completely through the respective aperture 934b in the gauge plate 930. In some embodiments, the transition section 946 may have an elliptical cross-sectional shape. In other embodiments, the transition section 946 may have a circular cross-sectional shape.

The cap bolt 940 further comprises a threaded end 948. The threaded end 948 resides at the end of the transition section 946 opposite the main body 942. The threaded end 948 is configured to receive a corresponding nut 950 to lock the cap bolt 940 in place and secure the gauge plate 930 to the clamping member 920. The threaded end 948 is also sized and configured to traverse and slide within the vertically-extending aperture 934a in the gauge plate 930 (see also FIGS. 16A-16B).

As noted above, the mounting gauge kit 900 may be used to define a mounting location for the active antenna module (radio) 110 on a mounting structure 130 relative to the mounting system 60 described herein. In use, a technician first secures the upper passive antenna bracket 160 to a mounting structure 130 (e.g., mounting pole P) via a pipe clamp 155 having at least one modified clamping member 920. Next, as shown in FIG. 16A, the cap bolt 940 is secured to the gauge plate 930 by inserting the threaded end 948 and transition section 946 of the cap bolt 940 through one of the horizontally-extending apertures 934b corresponding to the desired location along the mounting structure 130 that the upper pipe clamp 155 for the active antenna module (radio) 110 should be secured (i.e., in relation to the upper passive antenna bracket 160 of the mounting system 60, 600). A nut 950 is then loosely threaded onto the threaded end 948 of the cap bolt 940 to secure the cap bolt 940 to the gauge plate 930, but also allow the cap bolt 940 to traverse and slide within the selected horizontally-extending aperture 934b of the gauge plate 930. As shown in FIG. 16B, if the upper pipe clamp 155 for the active antenna module 110 needs to be secured at a different location along the mounting structure 130 (i.e., in relation to the upper passive antenna bracket 160 of the mounting system 60, 600), the cap bolt 940 is capable to also traverse and slide within the vertically-extending aperture 934a, for example, to move the cap bolt 940 to a different horizontally-extending aperture 934b that corresponds to the desired location along the mounting structure 130 that the upper pipe clamp 155 for the active antenna module (radio) 110. The nut 950 can then be tightened, thereby securing the cap bolt 940 in the desired location on the gauge plate 930.

As shown in FIGS. 17A-17B, after the cap bolt 940 is secured to the gauge plate 930, the gauge plate 930 is then mounted to the modified clamping member 920 by inserting the main body 942 and locking section 944 of the cap bolt 940 through the aperture 925a and corresponding slot 925b, respectively, in the flange 925. Using the gauge plate 930 as a guide, a technician can then mount the upper pipe clamp 155 for the active antenna module 110 to the mounting structure 130. As shown in FIG. 15A, by aligning the rods or bolts 118a of the pipe clamp 155 within one of the recesses 936 in the lower edge 932b of the gauge plates 130, the technician can secure the upper pipe clamp 155 at the desired location along the mounting structure 130.

In some embodiments, the base station antennas 100 may be designed so that a variety of different active antenna modules 110 can be used on/in a given antenna 100. The active antenna module 110 can be manufactured by any original equipment manufacturer and/or cellular service provider and mounted on the back of the antenna. This allows cellular operators to purchase the base station antennas and the radios mounted thereon separately, providing greater flexibility to the cellular operators to select antennas and radios that meet operating needs, price constraints and other considerations.

The antennas 100 may have a number of advantages over conventional antennas. As cellular operators upgrade their networks to support fifth generation (“5G”) service, the base station antennas that are being deployed are becoming increasingly complex. It is desirable to minimize antenna size and/or integrate increased number of antenna or antenna elements inside a single bases station antenna/external radome. For example, due to space constraints and/or allowable antenna counts on antenna towers of existing base stations, it may not be possible to simply add new antennas to support 5G service. Accordingly, cellular operators are opting to deploy antennas that support multiple generations of cellular service by including linear arrays of radiating elements that operate in a variety of different frequency bands in a single antenna. Thus, for example, it is common now for cellular operators to request a single base station antenna that supports service in three, four or even five or more different frequency bands. Moreover, in order to support 5G service, these antennas may include multi-column arrays of radiating elements that support active beamforming. Cellular operators are seeking to support all of these services in base station antennas that are comparable in size to conventional base station antennas that supported far fewer frequency bands.

The active antenna modules 110 may also be readily replaced in the field. As is well known, base station antennas are typically mounted on towers, often hundreds of feet above the ground. Base station antennas may also be large, heavy and mounted on antenna mounts that extend outwardly from the tower. As such, replacing base station antennas may be difficult and expensive. The active antenna modules 110 with beamforming radios may be field installable and/or replaceable without the need to detach the base station antenna 100 from an antenna mount.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.)

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The term “about” used with respect to a number refers to a variation of +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A base station antenna assembly, comprising:
a housing of a base station antenna comprising a passive antenna assembly and a passive reflector in the housing;
a plurality of passive antenna mounting brackets coupled to the housing and configured to attach to a mounting structure; and
an active antenna module comprising at least one active antenna mounting bracket configured to directly attach to the mounting structure, wherein, in an installed position, the active antenna module is behind the housing of the base station antenna.

2. The base station antenna assembly according to claim 1, wherein the active antenna module is independently attachable to the mounting structure whereby the active antenna module is directly supported by the mounting structure.

3. The base station antenna assembly according to claim 1, wherein the at least one active antenna mounting bracket comprises at least one mounting arm that extends rearwardly of a rear of the active antenna module to the mounting structure.

4. The base station antenna assembly according to claim 1, wherein the plurality of passive antenna mounting brackets comprise a first passive antenna mounting bracket and a longitudinally spaced apart second passive antenna mounting bracket, wherein the at least one active antenna mounting bracket and the active antenna module resides between the first and second passive antenna mounting brackets.

5. The base station antenna assembly according to claim 1, wherein the active antenna module comprises a massive multiple input multiple output (mMIMO) antenna array of radiating elements.

6. (canceled)

7. The base station antenna assembly according to Claim 1, wherein the plurality of passive antenna mounting brackets are configured to be adjustable to provide an adjustable distance between the active antenna module and a rear of the housing.

8. The base station antenna assembly according to Claim 1, wherein the plurality of passive antenna mounting brackets are configured to provide an adjustable downtilt of the housing.

9. The base station antenna assembly according to Claim 1, wherein the at least one active antenna mounting bracket is provided as a plurality of active antenna mounting brackets that are configured to provide an adjustable downtilt of the active antenna module.

10. The base station antenna assembly according to Claim 1, wherein the plurality of passive antenna mounting brackets are configured to provide an adjustable downtilt of the housing, and wherein the at least one active antenna mounting bracket is a plurality of active antenna mounting brackets that are configured to provide an adjustable downtilt of the active antenna module.

11. The base station antenna assembly according to claim 1, wherein the plurality of passive antenna mounting brackets and/or the at least one active antenna mounting bracket are configured to be adjustable to adjust a distance between a front of the active antenna module and a rear of the housing.

12. The base station antenna according to claim 1, wherein the plurality of passive antenna mounting brackets comprise mounting arms having a first length in a front to back direction, wherein the at least one active antenna mounting bracket comprises mounting arms having a second length in a front to back direction, wherein the mounting arms of the at least one active antenna mounting bracket extends from a rear of the active antenna module to the mounting structure, and wherein the first length is greater than the second length.

13.-20. (canceled)

21. A base station antenna assembly, comprising:
a housing of a base station antenna comprising an antenna assembly; and
a plurality of antenna mounting brackets coupled to the housing and configured to attach to a mounting structure, the plurality of antenna mounting brackets comprise an upper antenna mounting bracket, a middle antenna mounting bracket, and a lower antenna mounting bracket,
wherein the middle antenna mounting bracket comprises a rack and pinion assembly configured to adjust a distance of the housing of the base station antenna from the mounting structure.

22. The base station antenna assembly according to claim 21, wherein the middle antenna bracket further comprises a main body having two opposing sidewalls, each sidewall comprising an elongated slot, wherein the rack and pinion assembly is coupled to an outer surface of one of the sidewalls.

23. The base station antenna assembly according to claim 22, wherein the pinion of the rack and pinion assembly is held against an outer surface of one of the sidewalls by a fastener extending through the elongated slot, the fastener configured to allow the pinion to rotate relative to the sidewall such that the pinion can travel back-and-forth along the rack.

24. (canceled)

25. The base station antenna assembly according to claim 21, wherein the middle antenna mounting bracket further comprises a brake slider configured to engage the pinion of the rack and pinion assembly to lock the pinion in a position along the rack.

26. (canceled)

27. The base station antenna assembly according to claim 25, wherein at least a portion of the brake slider is configured to be received by and slide within the elongated slot of the bracket.

28. The base station antenna assembly according to claim 27, wherein the brake slider comprises an oval-shaped aperture through which the second fastener extends and allows the brake slider to slide back-and-forth relative to the fastener to engage or disengage the pinion.

29.-44. (canceled)

45. A base station antenna assembly, the assembly comprising:
a base station antenna comprising a housing containing one or more arrays of radiating elements, the one or more arrays of radiating elements configured such that an electronic downtilt can be applied to one or more antenna beams formed by the base station antenna; and
an antenna mount assembly coupled to the housing and configured to attach the base station antenna to a mounting structure, the antenna mount assembly configured to adjust the base station antenna to a desired angle of tilt relative to the mounting structure.

46. The base station antenna according to claim 45, wherein the antenna mount assembly is configured to adjust the base station antenna to a desired angle of uptilt.

47. The base station antenna according to claim 45, wherein the antenna mount assembly is configured to adjust the base station antenna to a desired angle of downtilt.

48. The base station antenna according to claim 45, wherein the antenna mount assembly is configured to be manually adjusted to the desired angle of tilt.

49. A base station antenna assembly, the assembly comprising:
a base station antenna comprising a housing containing one or more arrays of radiating elements, the one or more arrays of radiating elements configured such that an electronic downtilt can be applied to one or more antenna beams formed by the base station antenna; and
an antenna mount assembly coupled to the housing and configured to attach the base station antenna to a mounting structure, the antenna mount assembly configured to adjust the base station antenna to a desired angle of downtilt or a desired angle of uptilt relative to the mounting structure.
